(19) United States
(12) Patent Application Publication
(10) Pub. No.: US 2025/0322423 A1
(43) Pub. Date: Oct. 16, 2025

(54) INTERFACING RELATED TO ACTION AND REWARD

(71) Applicant: KUUDOH, INC., Bothell, WA (US)

(72) Inventors: Jacob Paul Graham, Bothell, WA (US); Ahmad Khamis Elshenawy, Lynnwood, WA (US)

(73) Assignee: KUUDOH, INC., Bothell, WA (US)

(21) Appl. No.: 19/037,273

(22) Filed: Jan. 26, 2025

Related U.S. Application Data
(63) Continuation of application No. PCT/US2023/028579, filed on Jul. 25, 2023.
(60) Provisional application No. 63/392,049, filed on Jul. 25, 2022.
(60) Provisional application No. 63/376,838, filed on Sep. 23, 2022.

(51) Int. Cl. G06Q 30/0207; G06Q 30/0241

(52) U.S. Cl. CPC G06Q 30/0209; G06Q 30/0277

(57) ABSTRACT

An embodiment comprises a first interface that may be configured for coupling to a computer system of a first party, a second interface that may be configured for coupling to a computer system of a second party, and a computer circuit that may be coupled to the first and second interfaces. The computer circuit may be configured to receive, from the first party, information regarding an action taken by a third party and related to the first party, and to associate the action taken by the third party with a reward available from the second party. The computer circuit further may be configured to associate the second party with a fourth party, and to notify the second party that the fourth party is eligible for the reward.

### CLAIM OF PRIORITY AND CROSS REFERENCE TO RELATED APPLICATIONS

This application claims the benefit of U.S. Provisional Application No. 63/376,838, filed Sep. 23, 2022, entitled TRANSACTION INTERFACING BETWEEN PHYSICAL AND DIGITAL ASSESTS, and U.S. Provisional Application No. 63/392,049, filed Jul. 25, 2022, entitled TRANSACTION INTERFACING BETWEEN GOODS/SERVICES AND VIRTUAL ASSETS, the contents of each of these aforementioned applications are hereby incorporated by reference as if fully set forth herein.

### BACKGROUND

Digital games, such as virtual games, are ubiquitous in modern entertainment. On a computer, laptop, tablet, smartphone, or other computing device, a person can access the Internet to play social games with other people, including gambling games or fantasy sports leagues. On a mobile smartphone, a person can download software applications, often called “apps,” from game providers to play puzzle games, racing games, action/adventure games, role playing games, logic games, and virtually any other type of game, with or without other players. On game consoles (and gaming computers), players can buy video-game disks to play on the game console and can even download, via a gaming marketplace, a wide selection of video games or gaming content straight to their console or computer.

Virtual games generally have several types of digital assets that players desire to acquire while playing and progressing through the game. For example, in a multiplayer shooting game, a player might want to earn virtual currency (e.g., credits) to unlock better weapons or armor skins. In a role-playing game, a player might want to defeat certain types of virtual opponents in the game for a chance to receive rare materials or gear (swords, shields, spells, rings, etc.) that boost the player's statistics (often called “stats”), but such rare materials or gear may have a very low chance of appearing, and thus would statistically require the player to play the game for a very long time conventionally to acquire these items. In more social games, the player may want to collect tokens or gems to advance within a level in the game, but must wait a certain period of time, perhaps on the order of several hours, before their own assets replenish enough to continue advancing through the game level. No matter the game, players who find a particular game enjoyable typically will want to acquire the game's digital assets so that the player becomes more adept at playing the game.

On the other end, merchants and retailers have an interest in promoting their assets (e.g., physical assets such as food or merchandise) to consumers for profit or other value. A merchant, for example, may have expiring goods in its inventory. If the merchant is unable to sell the goods either because consumers do not think that the goods are worth buying or because consumers are not aware of the goods before expiration, then the merchant typically disposes of the goods, resulting in a waste of money and loss of profits for the merchant. While merchants can promote their inventories, a merchant generally lacks the expertise or resources to work with other entities to create, in domains not managed by the merchant, incentives that will entice customers to make purchases. Even when inventory is priced competitively, or even after discounting inventory prices, a merchant may struggle to sell inventory on its own, or fail to create equitable and successful promotions in other domains that may entice customers to make purchases of promoted inventory.

### SUMMARY

The details of one or more embodiments are set forth in the summary and detailed description below. The features illustrated or described in connection with one exemplary embodiment may be combined with the features of other embodiments. Thus, any of the various embodiments described herein can be combined to provide further embodiments. Aspects of the embodiments can be modified, if necessary, to employ concepts of the various patents, applications and publications as may be identified herein to provide yet further embodiments.

There is provided according to embodiments an apparatus comprising a first interface that may be configured for coupling to a computer system of a first party, a second interface that may be configured for coupling to a computer system of a second party, and a computer circuit that may be coupled to the first and second interfaces and that may be configured to receive, from the first party, information regarding an action taken by a third party and related to the first party, and to associate the action taken by the third party with a reward available from a second party. The computer circuit coupled to the first and second interfaces may be further configured to associate the second party with a fourth party, and to notify the second party that the fourth party is eligible for the reward.

There is also provided according to embodiments an apparatus comprising a first interface configured for coupling to a computer system of a first party, a second interface configured for coupling to a computer system of a second party, and a computer circuit coupled to the first and second interfaces. The computer circuit may be configured to receive, from a first party, an identification of an action related to the first party, and to receive, from a second party, an identification of a reward available from the second party. The computer circuit may be further configured to associate a taking of the action with an eligibility to receive the reward.

The present disclosure enables transaction interfacing between physical assets and digital (such as virtual) assets, regardless of an inherent or intrinsic correlation between assets or between providers of said assets. In various examples, a merchant may have physical assets promoted by correlating one or more of its physical assets with one or more digital assets from a game managed by a digital-asset provider based on characteristics associated with both the physical asset and the digital asset, such as the type of asset, rarity of the asset, and/or the value of the asset. Not only may a merchant's physical assets and digital assets from a game be promoted in real-time, but the parameters of promotions covering assets may be modified, re-evaluated, or removed in real-time to account for changing circumstances, changing merchant preferences, and/or changing digital-asset-provider preferences. In doing so, the present disclosure may bridge economic parity between two otherwise very-different asset providers and dynamically coordinate asset and consumer data between multiple independent networks.

Embodiments of the present disclosure may be implemented via an independent third-party system that may receive data on characteristics of physical assets and patrons (i.e., persons and/or entities) associated with a merchant and data on characteristics of digital assets and users associated with a game managed by a digital-asset (e.g., a digital-game and/or a virtual-game) provider. The third-party system may include an artificial intelligence “AI” or artificial neural network or other machine-learning functionality to match at least one of the physical assets to at least one of the digital assets, and vise-versa. An artificial intelligence “AI” or artificial neural network or other machine-learning functionality, as described herein and/or relative to the third-party system may perform any other functions and/or operations, in addition to matching assets including at least one of the physical assets to at least one of the digital assets. The third-party system may generate an advertisement event designed to promote the matched assets and to display the advertisement event on websites, software apps, and/or other media platforms accessible to patrons of the merchant, digital-asset provider, and/or both.

In some embodiments, the third-party system may leverage data from a transaction associated with a patron of the merchant or digital-asset provider to determine whether to issue a reward that may be a physical asset or a digital-asset to the patron. The third-party system may include an artificial neural network or other machine-learning functionality to determine characteristics of the transaction, such as the types, amount, and/or price of the assets acquired from the transaction, and evaluate whether the transaction satisfies each parameter of an advertisement event. If so, the third-party system may direct the merchant and/or the digital-asset provider to issue the reward (e.g., an asset (digital and/or physical)) that is matched with another asset (physical and/or digital) acquired in the transaction) to one or more patrons associated with the transaction. In embodiments such as described herein, the transactions may include, generally, one or more physical assets that are matched with one or more digital assets and vice-versa, as well as transactions in which one or more physical assets are matched with one or more other physical assets and one or more digital assets are matched with one or more other digital assets. Furthermore, one or more physical and/or one or more digital assets may be matched with one or more other types of assets.

Methods directed to the embodiments described above are also disclosed, which methods may be performed by the third-party system or by one or more sub-systems or networks thereof.

Other embodiments are also disclosed as described further below.

### BRIEF DESCRIPTION OF THE DRAWINGS

Understanding that the drawings depict only exemplary embodiments and are not, therefore, to be considered limiting in scope, the exemplary embodiments will be described with additional specificity and detail through the use of the accompanying drawings, in which:

FIG. 1 is a diagram of a system including an access point interface (API) coupled to at least one merchant system and to at least one digital-asset-provider system, according to one or more embodiments;

FIG. 2 is a diagram of an exemplary access point interface (API) that is configured to coordinate between merchants and digital-asset providers, according to one or more embodiments;

FIG. 3 is a flow diagram of an exemplary method for registering physical and digital assets and/or services with, for example, a third-party system, according to one or more embodiments;

FIG. 4 is a diagram of a system including a promotion-generating subsystem configured to generate an advertisement event to at least one merchant and/or to at least one digital-asset provider, according to one or more embodiments;

FIG. 5 is a flow diagram of an exemplary method for generating an advertisement event to promote a physical asset and/or service with a digital asset and/or service, according to one or more embodiments;

FIG. 6A is diagram of an exemplary system configured to determine whether to match an asset with a reward and to determine whether an action regarding the asset satisfies a condition for receiving the reward, according to one or more embodiments;

FIG. 6B is a diagram of an exemplary system configured to determine whether to match an asset with a reward and to determine whether an action regarding the asset satisfies a condition for receiving the reward, according to one or more other embodiments;

FIGS. 6C-6D are a diagram of an exemplary system including a verification subsystem configured to determine whether to match an asset with a reward and to determine whether an action regarding the asset satisfies a condition for receiving the reward, according to one or more other embodiments;

FIG. 7 is a flow diagram of an exemplary method for determining a reward for a patron that transacted with either a merchant or digital-asset provider, according to one or more embodiments;

FIGS. 8A-8B are a diagram of system including a verification subsystem configured to determine whether to match an asset with a reward and to determine whether an action regarding the asset satisfies a condition for receiving the reward, according to one or more other embodiments;

FIG. 9 is a flow diagram of an exemplary method for determining a reward for a patron that acted with respect to an asset, according to one or more embodiments;

FIG. 10 is a flow diagram of an exemplary method for determining a reward for a patron that acted with respect to an asset, according to one or more other embodiments; and

FIG. 11 is a circuit diagram of a computing device, computing circuitry, and/or computing system on which any of the systems disclosed herein can be implemented, and which can be configured (e.g., by software, firmware, and/or data-configuration stream for, e.g., one or more FPGAs) to perform any of the functions and operations disclosed herein, according to an embodiment.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, software, configuration, and electrical changes may be made. Furthermore, the one or more methods presented in the drawing figures and in the specification are not to be construed as limiting the order in which the individual steps of a method may be performed, and the one or more methods may include steps or other items that, for clarity, are not disclosed expressly. The following detailed description is, therefore, not to be taken in a limiting sense.

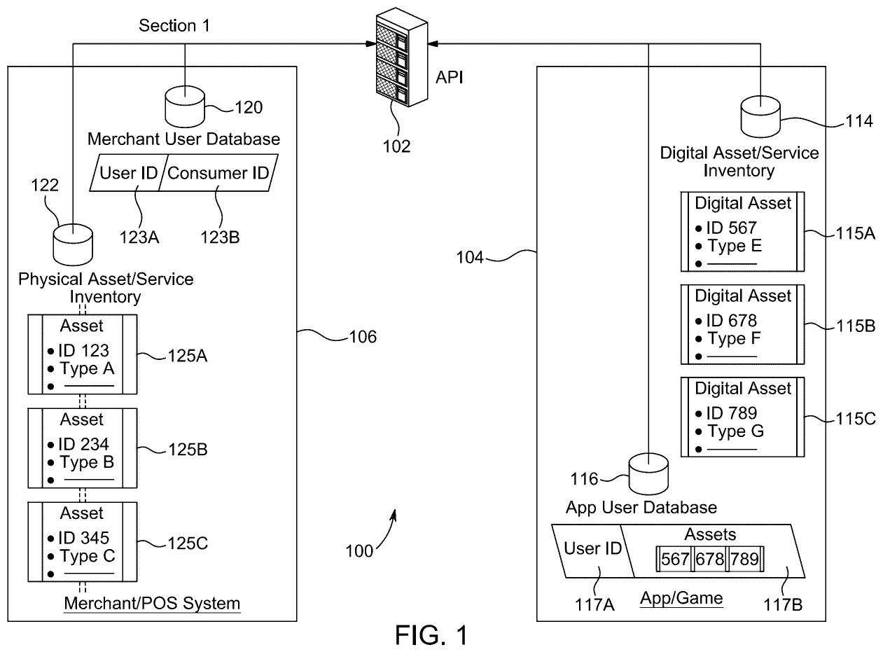

FIG. 1 is a diagram of a system 100 including an access point interface (API) 102 that is coupled to at least one first-party system that may be a computer system such as a merchant system 106, and to at least one second-party system that may be a computer system such as a digital-asset-provider system 104 (e.g., a gaming platform host). The API 102 can be implemented as a conventional API that serves as an access point to one or more networks operated by a third party (not shown in FIG. 1) and separate from the network(s) operated by the merchant and the network(s) operated by the digital-asset provider. Although only one merchant system 106 and one digital-asset-provider system 104 are expressly shown in FIG. 1, any number of merchant systems and digital-asset-provider systems can be coupled to the API 102, where, for example, each merchant system 106 corresponds to a different merchant and each digital-asset-provider system 104 corresponds to a different digital-asset provider.

The merchant system 106 comprises one or more networks (e.g., local area networks, wide area networks, enterprise networks) that are operated by, or associated with, a merchant, such as a grocery store, bookstore, vehicle dealership, a lawn care contractor, organization, or other type of merchant. In some embodiments, the merchant may operate a website that can be accessed by a consumer on a computer, or may manage a software application or other media platform that can be downloaded and accessed on a mobile device such as a smart phone or tablet. In some embodiments, the merchant system 106 is managed by a merchant partner entity that coordinates with the merchant on the physical assets or services provided by the merchant and/or the value/cost (if any) associated with the physical items or services.

As used herein, the term “merchant” means a person, group of persons, organization, or entity that provides a physical item and/or service (otherwise referred to as a “physical asset”), with or without value. For example, a grocery store can be classified as a merchant because it sells physical goods (food, greeting cards, plants, etc.) for a price that is paid by a consumer. A lawn-care business also can be classified as a merchant because it provides a service that would typically include mowing a customer's lawn, other landscaping, and other property-enhancement or maintenance work. But a non-profit organization such as a church also can be considered a “merchant” within the meaning of the term used herein because such an entity may provide an item and/or service (e.g., a church may provide a religious service) that may not be for commercial value. For example, a religious service provided by a church may be free to the public, or a non-profit organization may provide a service that supports the mission of the non-profit organization and request a donation for the service. Thus, the term “merchant” is intended to be construed broadly and not necessarily given the customary meaning as understood in the commercial or contractual context. Indeed, a transaction described with a merchant as used herein need not involve any money or may involve other forms of value such as virtual currencies, cryptocurrencies, barter, and/or trade.

In addition, in some embodiments the assets and/or services provided by a merchant may also include audio services, movie services, television services, streaming services, multimedia services, and/or other subscription based services, etc. For example, a TV/cable company or movie streaming service (merchant) may be interested in offering a reward for a gamer (e.g., a child) who plays a virtual game (e.g., provided by a game-hosting platform) when a customer (e.g., parent, sibling, gamer himself) purchases a movie or television series, or even just watches a movie that's already available as part of the customer's subscription service. In such an embodiment, it is understood that the audio services, movie services, television services, or other subscription-based services, etc. provided by the merchant may be considered to be digital assets and/or digital services that are provided by the merchant. As aforementioned, the term “merchant” is intended to be construed broadly and may include merchant service providers and/or merchant asset providers as described above that provide digital services and/or digital assets.

The digital-asset-provider system 104 comprises one or more networks (e.g., local area networks, wide area networks, enterprise networks) that are operated by, or associated with, an entity that provides a digital asset. In some embodiments, the digital-asset-provider system 104 hosts or manages a virtual game, e.g., on the Internet, that can be accessed by players. Alternatively, the digital-asset-provider system 104 can be configured to host or to manage a game on a software app on a mobile device, and/or may sell a video game for a game console or gaming computer that contains digital assets. In other embodiments, the digital-asset-provider system 104 may manage a database, or “library”, of games (or digital assets from games) from multiple different game developers in a centralized virtual marketplace where consumers may purchase or download a game or digital asset from a game directly from the virtual marketplace.

In an embodiment, the term “digital asset” means any non-physical asset for a virtual game. A digital asset can be any type of item obtainable in a virtual game, including a weapon, armor skin, experience points, power up, cheat code, digital achievements or events or scripting flags (such as defeating a special in-game enemy, beating a specific map, reaching a specific level, attending an in-game event, or logging in a specific amount of times in a month, etc.) and the like. A digital asset also can include virtual currency that can be spent for digital items in the game. A “customer, “consumer”, or “patron” refers to a person who enters into a transaction with a merchant or digital-asset provider.

In addition to “digital assets” in the context of the gaming and virtual gaming space, a digital asset may generally include anything of value that is created and stored digitally. This may include videos, audio, logos, websites, digitally rendered images, photos, documents, spreadsheets, data, and non-fungible tokens on a blockchain. Such digital assets may be uniquely identifiable and used to realize value.

Still referring to FIG. 1, the merchant system 106 is configured to record data on physical assets (e.g., inventory of goods, or services) offered by the merchant to consumers such as persons. For example, the merchant system 106 may store, in an asset database 122, a list of the physical assets 125A, 125B, 125C currently available for acquisition by a patron (e.g., a customer or other consumer). The asset database 122, in an embodiment, is configured to store metadata that includes an identification (ID) indicator of a physical asset and other characteristics of the physical asset, such as its name, description, value and/or cost, category, manufacturer, and/or type. For example, in a convenience store, an asset database 122 may store ID indicators on candy bars, soda, and/or other different types of snacks. As the merchant receives new inventory or updates its service list, the merchant system 106 can update the asset database 122 in time to reflect the change in physical assets.

Merchant system 106 also includes a user database 120 that is configured to store characteristics of patrons of the merchant. In some embodiments, the asset database 122 and the user database 120 are the same database. As shown in FIG. 1, in an embodiment user database 120 is configured to store a user ID 123A and a customer (consumer) ID 123B. The merchant system 106 is configured to store and to associate, with the user ID 123A, data on personal characteristics of the patron, potentially including their age or gender. The merchant system 106 is configured to store and to associate, with a consumer ID 123B, data on transactions associated with a consumer (or other user), such as the transaction history of the consumer. Some merchants employ a loyalty program or other incentive-based rewards system for customers to recurrently shop at the merchant and purchase physical assets at different times. The merchant system 106 can use this data to associate customers with specific physical assets of interest to the customer. Furthermore, the merchant system 106 can determine and/or collect, and can store, in the database 120, other customer/consumer-related metadata such as purchase preferences.

Digital-asset-provider system 104 includes a digital-asset database 114 configured to stores characteristics of digital assets 115A, 115B, 115C that are provided for a game or for multiple games managed by the digital-asset provider. The digital asset database 114, in an embodiment, is configured to store characteristics such as the name, description, category, rarity, type, and other such characteristics of each digital asset. For example, if a game includes a digital asset of a rare playable character to be unlocked, the playable character and the game in which it is unlockable can be saved in the digital-asset database 114.

Digital-asset-provider system 104 also includes a user database 116 configured to store characteristics of a user that plays a virtual game or otherwise engages with an offering of the digital-asset provider. For example, the user database 116 is configure to store a user ID 117A identifying personal characteristics such as the age or gender of a user. Additionally, the user database 116 may also be configured to store asset characteristics 117B that are associated with the user, including any digital assets previously acquired by the user while playing a virtual game. In some embodiments, the digital-asset database 114 and the user database 116 are the same database.

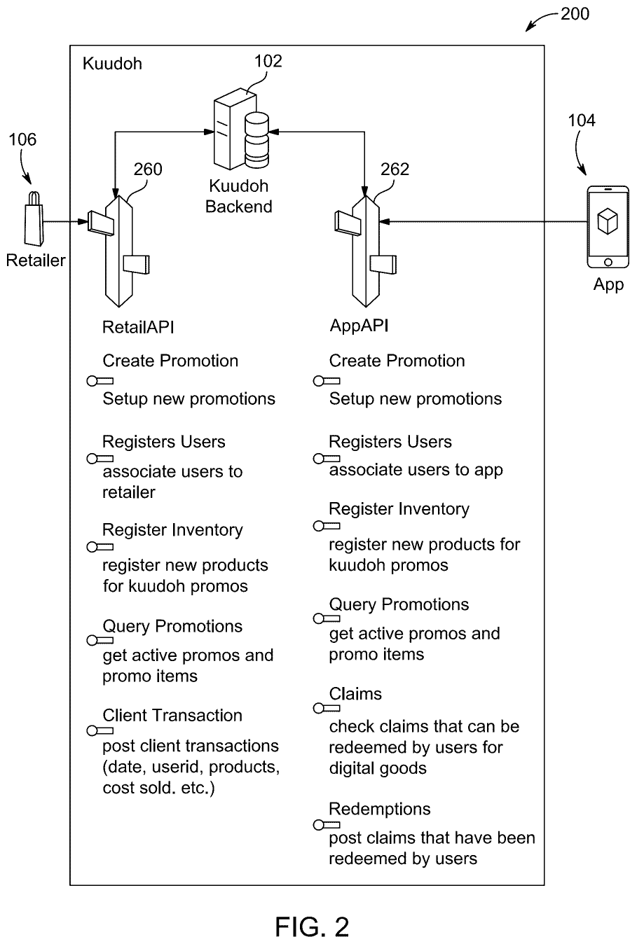

Communicatively coupled to the merchant system 106 and to the digital-asset-provider system 104 is API 102. The API 102 is configured to receive characteristics of both physical assets from each merchant system 106 and digital assets from each digital-asset-provider system 104, along with the user characteristics from each system, and to register physical and digital assets. For example, FIG. 2 is a diagram of a system 200 that includes an exemplary access point interface (API) 102 that coordinates between merchants and digital asset providers, which can be implemented as the API 102 of FIG. 1. Referring to FIG. 2, API 102 is communicatively coupled to a merchant system API 260 that is connected to at least one first-party system that may be a computer system such as a merchant system 106. API 102 is also communicatively coupled to a digital-asset-provider system API 262 that is connected to at least one second-party system that may be a computer system such as a digital-asset-provider system or gaming-platform host 104. Based on asset-characteristics data and user-characteristics data provided from both merchant system 106 and digital-asset-provider system 104, API 102 is configured to register new or updated assets and to register users. On the side of the merchant system 106, the API 102 can send and query advertisement events to merchant system 106 and receive customer transactions such as the date of a transaction, assets listed in the transaction, and cost of the assets, from the merchant system 106. On the digital-asset-provider side, API 102 can send and query advertisement events to digital-asset-provider system 104, check claims that can be redeemed by patrons for digital assets, and post claims that have been redeemed by patrons.

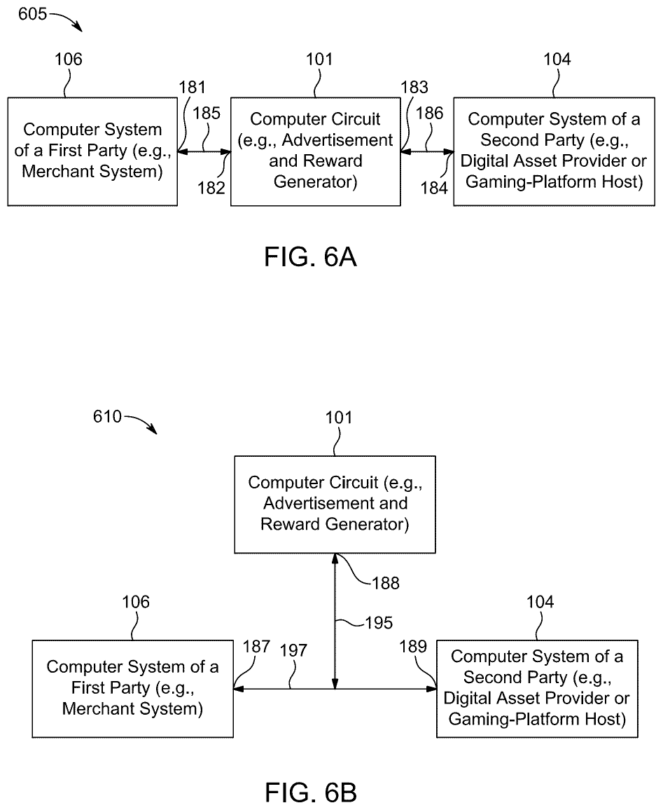

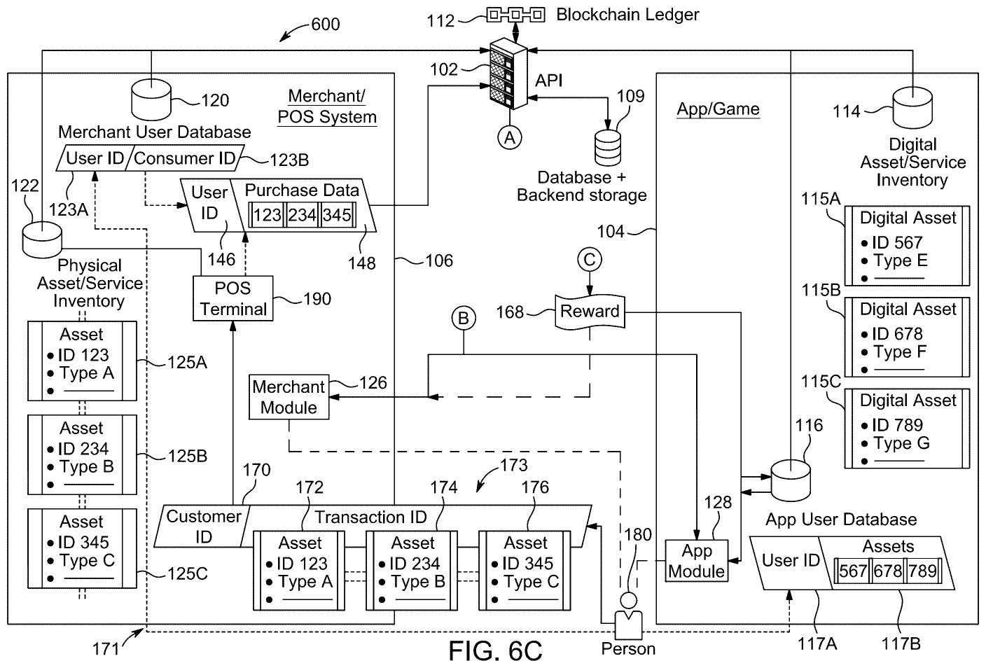

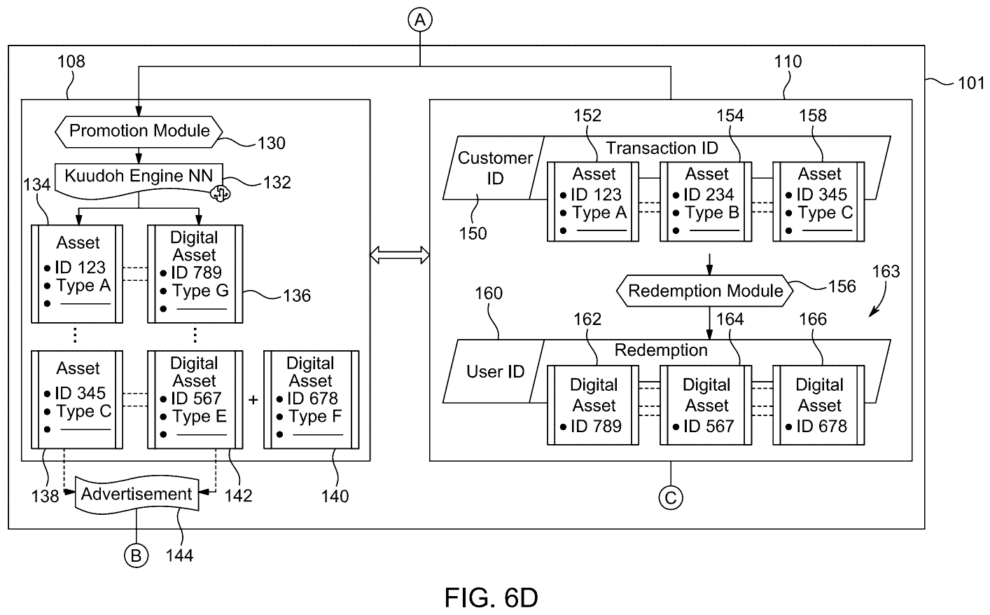

Referring to FIG. 6C in conjunction with FIG. 1, as is described below in further detail, embodiments of the system 100 including the access point interface (API) 102 coupled to at least one merchant system 106 and at least one digital-asset-provider system 104 may further comprise a blockchain ledger 112 or other type of record keeping or database systems coupled to API 102. The system 600 illustrated in FIG. 6C can be implemented using the system 100 described in the context of FIG. 1, with reference numerals identical between FIG. 1 and FIG. 6C denoting similar components performing the same functionality in FIG. 6C as described in FIG. 1; that is, the system 100 may form part of the system 600. The blockchain ledger 112 or other database/backend storage 109 that is coupled to the API 102 may be configured to store any previously generated advertisement events, user transactions, and/or reward information. In the blockchain ledge 112 and/or other database/backend storage 109, all information may be updated as new advertisement events, transactions, and rewards are generated. For example and as will be detailed further herein, if the system 100 generates a new advertisement event or modifies an existing event, the advertisement event information, including parameters of the advertisement event, may be sent to API 102 and recorded in blockchain ledger 112 or other database/backend storage 109 of the system 100. When a patron of the merchant system 106 or digital-asset-provider system 104 completes a transaction or is issued an asset reward, a verification system may send the reward information to API 102 and is recorded in blockchain ledger 112. Blockchain ledger 112 can may record when a patron claims a reward. As an example, blockchain ledger 112 can record any of the following parameters: merchant ID, digital asset provider ID, user ID and metadata, transaction ID and metadata, physical asset ID and metadata, and/or digital asset ID and metadata.

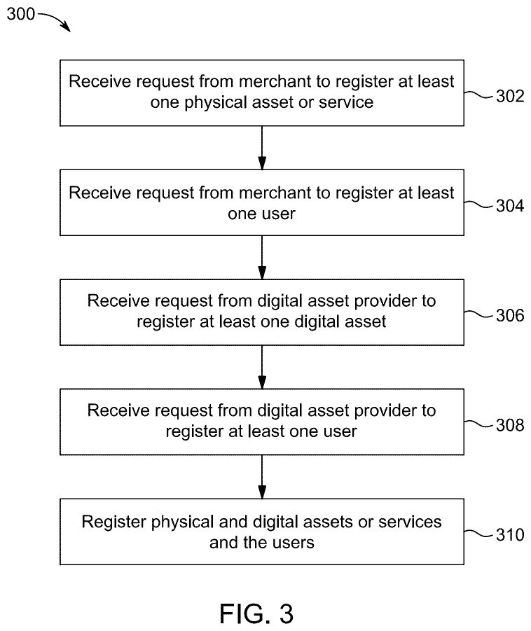

In an embodiment, the API 102 can register users and assets as illustrated in FIG. 3, which is a flow diagram of an exemplary method 300 for registering physical and digital assets or services. The blocks of the flow diagram have been arranged in a generally sequential manner for ease of explanation; however it is to be understood that this arrangement is merely exemplary, and it should be recognized that the processing associated with the methods described herein (and the blocks shown in the Figures) may occur in a different order (for example, where at least some of the processing associated with the blocks is performed in parallel or in an event-driven manner). Also, a description of standard exception handling is omitted for clarity and for ease of explanation; however, it is to be understood that method 300 can and typically would include such exception handling.

Method 300 includes receiving a request from a merchant system, such as merchant system 106 of FIG. 1, to register at least one physical asset or service at a step 302. For example, the API 102 receives a POST request from the merchant system API 260 with at least one physical asset or service that the merchant wishes to register for use in a promotion. Referring to FIG. 1, the merchant system 106 can retrieve at least one physical asset or service from the asset database 122 and can send the retrieved at least one physical asset or service to the API 102.

Method 300 also includes receiving a request from the merchant system 106 to register at least one user at step 304. In some embodiments, the request to register users also includes a request to register the physical asset or service as described in step 302. Referring to FIG. 1, the merchant system 106 can retrieve information regarding the at least one user from the user database 120 and send the retrieved information to the API 102.

At step 306, the API 102 receives a request from the digital-asset-provider-system 104 to register at least one digital asset. For example, the API 102 receives a POST request from the digital-asset-provider system API 262. Referring to FIG. 1, the digital-asset-provider system 104 can retrieve, from the digital asset database 114, information describing, or otherwise related to, at least one digital asset from the digital-asset database 114 and can send the retrieved information to the API 102.

At step 308, the API 102 receives a request from the digital-asset-provider system 104 to register at least one user of a virtual game hosted or managed by the digital-asset provider. For example, the digital-asset-provider system 104 can retrieve information regarding the at least one user from the user database 116 and send the information to the API 102. In some embodiments, the request to register at least one digital asset per in step 306 also includes a request to register the at least one user described in step 308.

Method 300 proceeds to step 310 in which the API 102 registers (e.g., in a database of a third party network connected to API 102) the at least one physical asset from the merchant system 106 and also the at least one digital asset from the digital-asset-provider-system 104 in the third party network connected to the API 102 database. Additionally, the identities of users received by the merchant system 106 and the digital-asset-provider system 104 are also registered in the same and/or a different database. The database used to register the users and assets can exist on a network separate from the merchant system 106 and the digital-asset-provider system 104, such as a blockchain ledger 112 (as shown in FIG. 6C) or other type of record keeping or database systems coupled to API 102.

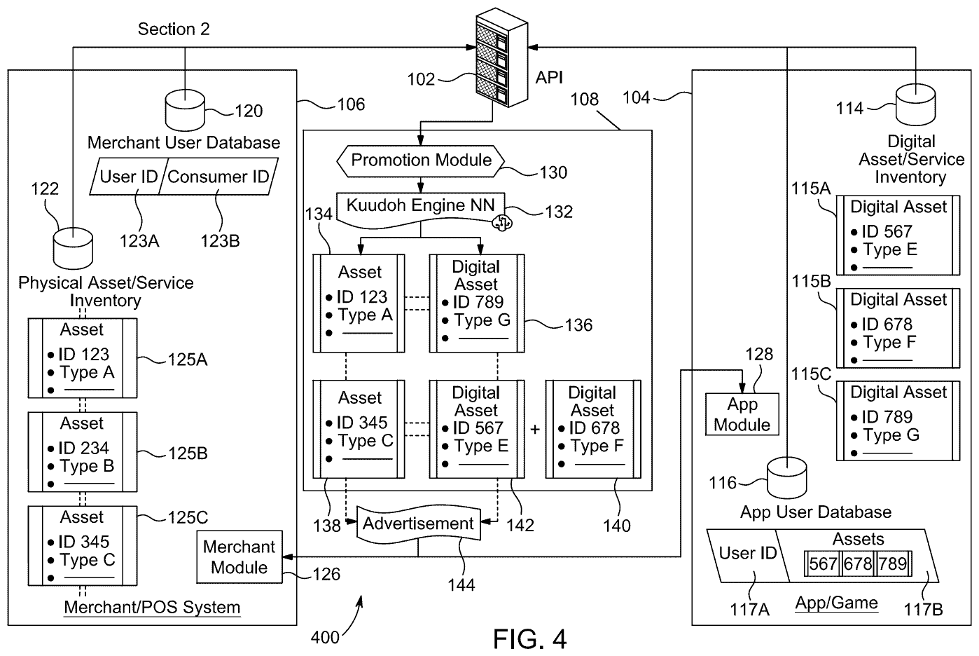

FIG. 4 is a diagram of a system 400 including a promotion-generating system 108 configured to generate an advertisement event to at least one merchant and at least one digital-asset provider, according to an embodiment. The system 400 illustrated in FIG. 4 can be implemented using the system 100 described in the context of FIG. 1, with reference numerals identical between FIG. 1 and FIG. 4 denoting similar components performing the same functionality in FIG. 4 as described in FIG. 1; that is, the system 100 may form part of the system 400.

In system 400, API 102 is coupled to a promotion-generating system 108, which can be located on a separate network from the merchant system 106 and the digital-asset-provider system 104. At a fundamental level, the promotion-generating system 108 is configured to use the user and asset characteristics data provided by the merchant system 106 and the digital-asset-provider system 104 and to generate one or more advertisement events 144 that promote, or otherwise relate, a physical asset offered by the merchant to a digital asset offered by the digital-asset provider, or vise-versa. As part of the promotion-generating process, promotion-generating system 108 evaluates characteristics of at least one physical asset and at least one digital asset to determine a suitable pairing between a physical asset and a digital asset.

The merchant system 106 optionally can send to the API 102 (e.g., by the same request used to register the at least one physical asset as previously described) a list of one or more selected physical assets that the merchant desires to promote. A grocery-store merchant, for example, may want to target older merchandise that is set to expire the same day or in a very short timeframe in order to sell additional merchandise that it normally would not be able to sell absent a targeted promotion on the merchandise. In another example, a video-game store may want to promote a new video game on the date for which the new video game is to be released to the general public, and may desire to entice its customers to purchase the new video game using a targeted promotion (perhaps with one or more digital assets that are in the video game). When a merchant desires to select particular physical assets (including any services provided by the merchant), the merchant system 106 can send the selected physical assets (and/or services) to the API 102 along with a request to use the selected physical assets (and/or services) for an advertisement event. The merchant also can specify other preferred characteristics, such as the length of the advertisement event or the price (or price range) of the physical assets during the advertisement event. Also, a merchant can select a combination of one or more physical assets to use in an advertisement event, such as a set of tires to be installed in a vehicle, or a purchase of one or more tires in conjunction with a tire rotation performed by the merchant, in the same advertisement event. However, the selecting of physical assets by the merchant is optional and is not necessary to generate an advertisement event because promotion-generating system 108 may select registered physical assets associated with the merchant system 106 without additional input from the merchant.

The promotion-generating system 108 includes a promotion module 130. The promotion module 130 is configured to identify registered physical assets from the merchant system 106 and registered digital assets from the digital-asset-provider system 104, including related metadata comprising all relevant history, status, and purchase data from all user IDs, in order to properly create and to modify all promotional criteria. A combination of the metadata (or other information) of consumers of physical assets in the merchant system 106 with the metadata (or other information) of gamers in the digital-asset-provider system 104 may be utilized by the promotion-generating system 108 for generating an advertisement event 144. For example, when the API 102 receives a request from the merchant system 106 to generate an advertisement event using its physical assets, the promotion module 130 can look up registered physical assets that correspond to that particular merchant. Additionally, promotion module 130 can select physical assets registered to the merchant that correspond to a specific consumer demographic based on the user characteristics data of registered patrons. For example, assume a toy store merchant desires to create a promotion geared towards younger boys of age between 5-8 years. Promotion module 130 reviews the registered inventory from the toy store merchant and selects potential toy items to use for an advertisement event 144 based on the characteristics associated with the registered inventory. In this example, promotion module 130 determines, from the type of toys that are registered to the toy merchant (an example of an asset type characteristic), that model cars, action figures, and water guns should be used as potential items in the advertisement event 144. Promotion module 130 may also be configured to ensure that a promotion presents selected physical assets that are appropriate for a particular merchant. In particular, based on the user characteristics data of registered patrons, an appropriate selection of physical assets may be made that is suitable for the targeted merchant. For example, in the aforementioned example of creating a promotion geared towards younger boys of age between 5-8 years, the promotion module 130 may be able to discern between presenting toys versus household cleaning products according to the user characteristics data of registered 5-8 year-old-patrons. That is, in an embodiment, the promotion module 130 is configured to determine that it is appropriate to present toys to 5-8-year-old boys but it is inappropriate to present cleaning products to 5-8-year-old boys.

In another example of the promotion module 130, a car dealership may desire to promote a car-maintenance service to customers who recently purchased a used car. Promotion module 130 identifies, from the registered services that corresponds to the car dealership, an oil change or tire rotation service (an example of an asset type or asset description characteristic). Optionally, promotion module 130 also identifies one or more patrons from the registered user database 120 that are linked to a recent car purchase from the car dealership whose car may be in need of an oil change or tire rotation service.

Additionally, promotion module 130 identifies one or more digital assets that correspond to the digital-asset-provider system 104 based on the registered digital asset and user data. For example, for a promotion designed to target older patrons (of 50 years of age or more) who are more likely to play social or puzzle games, promotion module 130 may identify digital assets from a crossword game offered by a digital-asset provider, such as a free letter to solve a puzzle clue or virtual currency in the puzzle game. The promotion module 130 additionally may identify a digital asset from a farming simulation game offered by the same or different digital-asset provider, such as a rake or rare crop, to use in generating the advertisement event 144. The promotion module 130 then provides the potential physical and digital assets to the evaluation engine 132. Promotion module 130 may also exclude specific patrons from certain promotions or offer completely different promotion pairings, based on the user's relevant information, metadata, history, and status. For example, a merchant may choose to not allow any promotions related to sandwiches to be offered to customers who already have a history of purchasing sandwiches. Or a game could choose to not allow gamers that have recently spent money in their game to receive any promotions, regardless of any other factors (because the promotion module or merchant realizes that such gamers need no incentive to spend money in the game). In an embodiment, the system 100 may include an additional database dedicated to storing the patrons that have been excluded from certain promotions or the patrons for whom the physical-asset providers may need to review and to approve, prior to issuance of a promotion by the promotion-generating system 108.

Evaluation engine 132 is configured to evaluate the characteristics of the physical and digital assets identified by promotion module 130 and to match one or more physical assets to one or more digital assets based on the characteristics. For example, evaluation engine 132 can consider any one or more of the characteristics of the registered physical asset (e.g., price/value, description of the asset, product line, asset type, historical sales data, target end-user demographic data, stock/availability, rarity of the asset, asset manufacturer, and other characteristics) and any one or more of the characteristics of the registered digital asset (e.g., asset description, asset type, rarity of the asset, asset category, price/value, historical sales/purchase data, historical engagement data of how popular an asset for purchase or frequently consumed in the game, and other characteristics).

In an exemplary embodiment, evaluation engine 132 is configured to calculate a pairing score between a physical asset and a digital asset. For example, a physical asset can be selected and paired with a first digital asset and a pairing score is calculated based on an evaluation of the characteristics associated with the physical asset and the digital asset. The physical asset then can be paired with a second digital asset, and a second pairing score is calculated based on the characteristics associated with the physical asset and the second digital asset. This process can be repeated iteratively for each physical asset and digital asset pairing permutation. The pairing scores can then be ranked and the physical asset and the digital asset associated with the highest pairing score can be used as assets for an advertisement event 144. Optionally, multiple pairing scores can be calculated for a given physical and digital asset pairing, in which each of pairing scores is calculated with a different weighting evaluation of the characteristics. For example, one pairing score may be calculated between a given physical asset and digital asset that more heavily weighs the rarity of the digital asset with the value of a physical asset, while another pairing score with the same physical asset and digital asset may yield a different pairing score that more heavily weighs the type of the physical asset with the historical engagement data of the digital asset.

A physical asset may be paired with multiple digital assets. For example, a bag of chips could be paired with a sword in a video game, digital currency in a mobile game, and a temporary power up in a virtual multiplayer game. Multiple physical assets can also be paired with a single digital asset, including physical assets from multiple merchants. An advertisement event 144 can include each of the multiple paired assets (e.g., if each of the multiple assets that are paired belong to the same merchant), or separate advertisement events can be generated for each of the multiple paired assets. A physical or digital asset may also be paired at a free or discounted rate, depending on the asset pairing and criteria, especially in cases where the digital asset criteria is an in-game achievement, event, or digital scripting flag.

As shown in FIG. 4, evaluation engine 132 generates an output indicative of at least one paired physical asset 134 with at least one digital asset 136. In some embodiments, a physical asset 138 is paired with multiple digital assets 142 and 140. Each physical asset 134 and each digital asset 136 includes one or more characteristics such as the identifier of the physical/digital asset and the type of asset. For example, a physical asset in a grocery store may include an identifier used by the store to categorize inventory, whereas a digital asset identifier may correspond to a code segment used in a virtual game.

In some embodiments, evaluation engine 132 includes one or more machine learning algorithms implemented by one or more artificial neural networks (ANN). The ANNs comprise an input layer that receives the input parameters (e.g., the identified physical and digital assets from promotion module 130, along with their associated characteristics data) and an output layer that generates an output indicative of a correlation between a physical asset and a digital asset. The ANNs further comprise one or more hidden layers between the input and output layer configured to implement machine learning techniques. The ANNs may include any type of neural network, such as a deep neural network (DNN), recursive neural network (RNN), and other such networks. Each layer in the ANN may comprise one or more nodes that are each implemented by one or more processing units, or by a portion of one or more processing units. The other engines described herein can be performed using one or more ANNs.

Promotion-generating system 108 is configured (e.g., by the evaluation engine 132) to generate an advertisement event 144 including the one or more physical assets that are matched with the one or more digital assets. The parameters of the advertisement event 144 are determined based on data such as the characteristics of any currently active promotions between the merchant and the digital-asset provider, the time of day, the time of year (seasonality), temperature or weather events associated with the location of the merchant or users associated with the merchant, holidays, regional events, historic promotional data, merchant data stored in real-time, and/or other information. For example, to promote food with a sell date expiring at the end of the day, the food is matched with a suitable digital asset and an advertisement event 144 is generated in real-time that gives patrons the digital asset if they purchase a specified (e.g., in the advertisement), or otherwise suitable, quantity of the food by the time that the store closes or by midnight, whichever is sooner. In another example, an advertisement event 144 may span a few weeks during the month of October in which patrons of a grocery store will obtain a suitable digital asset if they purchase a suitable monetary amount and/or value of fun-sized candies for Halloween. In another example, the advertisement event 144 may be for a discounted or free physical asset from the merchant if the digital asset required for the promotion is obtaining a specific achievement in a computer or other type of virtual game (such as acquiring an extremely rare item in the game). Also, the promotion-generating system 108 may be configured to avoid promoting products to a particular consumer who is known to be buying such products already without the incentive of a promotion. In such a scenario, the promotion-generating system 108 may promote, to the particular consumer, other products that the particular consumer is not already purchasing.

In the context of generating an advertisement event 144 including a potential reward in the form of a digital asset, the promotion-generating system 108 and/or the digital asset itself may also provide or unlock access to a specific item to use in the virtual game, or may correspond to a probability of obtaining a certain amount of items in the game (e.g., a patron may be granted a code to redeem for an 80% chance to earn 100 gems in a mobile game, a 15% chance to earn 500 gems, or a 5% chance to earn 1000 gems based on a single purchase); alternatively, the digital asset itself may be the access or the probability. Also, the rewards associated with a pending advertisement event 144 may change (e.g., increase) based on the amount of times a patron has completed the transaction. As one example, a score multiplier in a virtual game may be increased by one (1) each time the patron completes a qualified transaction during the advertisement event 144. In addition, the rewards associated with a pending advertisement event 144 may vary and change in the type of physical or digital asset that may be awarded, so that the rewards may avoid the likes of a credit-card reward point system or similar point incentives of that nature in which only points are awarded.

In addition to the paired assets, the advertisement event 144 may include other parameters such as the duration of the event, the event's start and end dates, the maximum spending amount, sales-commission rate, digital artwork/text for the event, and other parameters. The digital artwork or text can be provided by the merchant or digital-asset provider, or can be generated as part of the advertisement event 144 by the promotion-generating system 108. In some embodiments, an advertisement event 144 is a one-time promotion that is set during a specific period of time (e.g., a few hours, an entire month, or a date-specific range). Alternatively, the advertisement event 144 is a recurring promotion that can be redeemed multiple times per day, daily, weekly, or monthly, by a patron. Promotions subject to the advertisement event 144 are tracked via API 102 and may reward patrons with a special of reward for engaging with promotions over time. For example, advertisement event 144 maybe be configured to promote a special “combination” bonus and unlock an extra reward for patrons after completing multiple promotions in a given timespan (day, week, month, etc.). For example, a patron might participate in three promotions in a single day (and earn a reward for all three promotions), and then earn a bonus reward that day as well simply for his participation in multiple (here three) promotions in a single day. These types of rewards may differ from rewards offered in other promotions due to recurring activity being rewarded instead of rewarding the purchasing of specific products or other activity. In addition to “combination” bonuses, an advertisement event 144 may include “chance” bonuses where participation in a promotion may be accompanied by a percentage stake or chance in winning an additional reward.

The promotion-generating system 108 is configured to send the advertisement event 144 to each merchant system 106 (e.g., by a merchant interface module 126) and to each digital-asset-provider system 104 (e.g., by an app interface module 128). The merchant and digital-asset provider can review the advertisement event 144, including the physical and digital assets selected for promotion. If the merchant and digital-asset provider both approve the advertisement event 144, they can simply allow the advertisement event 144 to come into effect without further action. Conversely, if either the merchant or the digital asset provider does not approve the advertisement event 144, then the merchant or digital-asset provider can select one or more of their own assets to replace the assets that were paired by the promotion-generating system 108. The merchant or digital asset provider can modify other parameters of the advertisement event 144, including the length of the advertisement event, the start and/or end date of the event, the minimum and/or maximum spend amount, the type of advertisement, the type of merchant/digital-asset provider that owns the assets, and other parameters.

When the merchant and/or digital-asset provider modifies the advertisement event 144, the modification is sent back to the promotion-generating system 108, which is configured to replace the originally paired asset with the assets selected by the merchant or digital-asset provider that sent the modification. An advertisement event 144 that is approved by the merchant and digital-asset provider, or an advertisement event 144 modified based on the feedback from the merchant and/or digital-asset provider, can be finalized and made active on the merchant interface module 126 and/or the app interface module 128. A patron may then access the merchant interface module 126 or the app interface module 128 via their mobile device (smartphone, laptop, etc.) and views the advertisement event 144 displayed on the device. In an embodiment, an advertisement event 144 may also be viewed by a patron while playing a virtual game, while visiting a virtual-game store associated with a digital-asset-provider system 104, while reviewing a merchant loyalty application associated with a merchant system 106, and/or in any other suitable manner.

Promotion-generating system 108 can modify or cancel an advertisement event 144 based on updated asset data that is provided in real-time by the merchant system 106 and/or digital asset provider system 104. If an asset is selling too quickly, promotion-generating system 108 can be configured to determine an alternate asset (e.g., by evaluation engine 132) and substitute the current asset with the alternate asset. As another example, promotion-generating system 108 can adjust, dynamically, the parameters of the advertisement event 144 at certain times of the day to favor physical assets that are expiring at the end of the day.

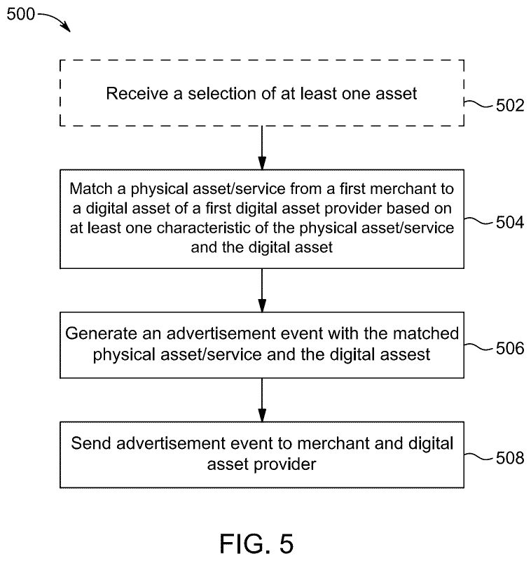

One example of a method for generating an advertisement event that matches a physical asset to a digital asset is shown in FIG. 5. In one embodiment, a method represented by the flow diagram 500 is performed by, or otherwise in conjunction with, the promotion-generating system 108 of FIG. 4. Although the method of diagram 500 is described as being performed by the promotion-generating system 108, it is understood that any other suitable device can perform the method.

The method of flow diagram 500 optionally includes the promotion-generating system 108 receiving a selection of at least one physical asset or service from a merchant at step 502. This step is optional because a physical asset can be matched with a digital asset without input from the merchant. However, if a physical asset is provided to the promotion-generating system 108 by the merchant at step 502, then that physical asset is used to match with a digital asset at step 504. Conversely, the promotion-generating system 108 can receive a digital asset from a digital asset provider to match with a physical asset at step 502.

The method of the flow diagram 500 proceeds to step 504, during which the promotion-generating system 108 matches a physical asset and/or service to a digital asset based on at least one characteristic of the physical asset and/or service and the digital asset. The characteristics can include price/value, description of the asset, product line, asset type, historical sales data, target end-user demographic data, stock/availability, rarity of the asset, asset manufacturer, and/or other characteristics, and/or any one or more of the characteristics of the registered digital asset (e.g., asset description, asset type, rarity of the asset, asset category, price/value, historical sales/purchase data, historical engagement data of how popular an asset for purchase or frequently consumed in the game, and other characteristics). The promotion-generating system 108 can pair multiple physical assets associated with one or multiple merchants with a digital asset, and/or can pair multiple digital assets associated with one or multiple digital-asset providers with a physical asset. In some embodiments, matching a physical asset or service to a digital asset includes the promotion-generating system 108 generating at least one pairing score between the physical asset or service and the digital asset. The at least one pairing score hen can be ranked and the physical asset and the digital asset associated with the highest pairing score can be used as assets for an advertisement event 144. Optionally, the promotion-generating system 108 can calculate multiple pairing scores with a different weighting evaluation of the characteristics for a given physical and digital asset pairing.

At step 506, the promotion-generating system 108 generates an advertisement event with the matched physical asset and/or service and the digital asset. The promotion-generating system 108 determines the parameters of the advertisement event 144 based on data such as the characteristics of any currently active promotions between the merchant and the digital-asset provider, the time of day, the time of year (seasonality), temperature or weather events associated with the location of the merchant or users associated with the merchant, holidays, regional events, historic promotional data, merchant data stored in real-time, and/or other information. In addition to the paired assets, the advertisement event 144 can include other parameters such as the duration of the event, the start and/or end date, the minimum and/or maximum spending amount, sales commission rate, digital artwork/text for the event, and/or other parameters. The digital artwork or text can be provided by the merchant and/or digital-asset provider, or can be generated as part of the advertisement event 144 by the promotion-generating system 108. In some embodiments, an advertisement event 144 is a one-time promotion that is set during a specific period of time (e.g., a few hours, an entire month, or a date specific range). Alternatively, the advertisement event 144 is a recurring promotion that can be redeemed multiple times per day, weekly, and/or monthly by a patron.

The promotion-generating system 108 then proceeds to step 508 and sends the advertisement event 144 to at least one merchant and to at least one digital-asset provider, e.g., by displaying the advertisement event 144 on a website or software app associated with the merchant or the digital-asset provider. Optionally, the merchant or the digital asset provider reviews the advertisement event 144 prior to the promotion-generating system 108 displaying the advertisement event 144 and may modify one or more parameters of the advertisement event 144. In this case, the promotion-generating system 108 modifies the advertisement event 144 based on the feedback from the merchant or the digital-asset provider and, once the advertisement event 144 is finalized, is displayed by the merchant system 106 or the digital-asset provider system 104 where it can be seen by patrons of the merchant or the digital-asset provider on, for example, their mobile devices.

FIG. 6A is a diagram of an exemplary system 605 including at least one first-party system that may be a computer system (e.g., a merchant system 106), at least one second-party system that may be a computer system (e.g., a digital-asset-provider system or gaming-platform host 104), and at least one computer circuit (e.g., an advertisement and reward generator 101, for example, stand alone or included as part of a promotion-generating system 108) configured to determine whether a user transaction in a physical-or digital-asset event satisfies the parameters of an advertisement event. As will be described in further detail, the exemplary system 605 of FIG. 6A may be generally configured to determine whether to match an asset of the first-party system with a reward of the second-party system (or an asset of the second-party system with a reward of the first-party system) and determine whether an action regarding the asset satisfies a condition for receiving the reward. The system 605 may be further configured to notify either or both of the first-party system and second-party system that a patron or user of the system 605 (such as a grocery shopper or virtual gamer), or a component thereof (e.g., the first-party system 106 or the second-party system 104) is eligible for the reward.

As shown in the exemplary system 605 of FIG. 6A, each of the first-party system (e.g., a merchant system 106), at least one computer circuit (e.g., an advertisement and reward generator 101, for example, stand alone or included as part of a promotion-generating system 108), and second-party system (e.g., a digital-asset-provider system or gaming-platform host 104) may include respective input/output ports in communication with an interface such as a bus. For example, the first-party system 106 may include an input/output port 181 that is coupled via an interface 185 to an input/output port 182 of the at least one computer circuit 101. The second-party system 104 may include an input/output port 184 that is coupled via an interface 186 to an input/output port 183 of the at least one computer circuit 101.

As further shown in FIG. 6A, the system 605 may include the advertisement and reward generator 101 communicatively coupled to the at least one first-party system that may be a computer system such as a merchant system 106, and coupled to the at least one second-party system that may be a computer system such as a digital-asset-provider system 104. The advertisement and reward generator 101 may be part of, may be, or may include a promotion-generating system 108, as described in the embodiments herein. The promotion-generating system 108 may be configured to use the user and asset-characteristics data provided by the merchant system 106 and the digital-asset-provider system 104 and to generate one or more advertisement events 144 that promote a physical asset offered by the merchant in conjunction with a digital asset offered by the digital-asset provider, or vise-versa. As part of the promotion-generating process, promotion-generating system 108 may evaluate characteristics of at least one physical asset and at least one digital asset to determine a suitable pairing between a physical asset and digital asset.

Referring again to FIG. 6A, the advertisement and reward generator 101 may further include a verification system 110, as described in the embodiments herein, that may be configured to determine whether a patron transaction satisfies the criteria of an advertisement event 144. Together, the verification system 110 and the promotion-generating system 108 of the advertisement and reward generator 101 in FIG. 6A may exchange and associate data for purposes of generating advertisements and rewards.

To illustrate an example hypothetical scenario in view of the exemplary system 605 of FIG. 6A, the advertisement and reward generator 101 may receive information from a first-party system that may be a computer system such as a merchant system 106 regarding an action, such as a purchase, that is taken by a third party grocery shopper to purchase a good at the merchant system 106. The advertisement and reward generator 101 may then associate the action or purchase made by the third party (e.g., the parent of a gamer, the parent being a member of a loyalty program associated with the merchant that owns the merchant system 106) with a digital reward available (e.g., a “life” or other asset related to a virtual game) from the second-party system that may be a computer system such as a gaming-platform host or digital asset provider system 104. Then, the advertisement and reward generator 101 may associate the second-party system that may be a computer system such as a digital asset provider system 104 with a fourth party such as a virtual gamer, and notify the digital-asset-provider system 104 that the fourth party is eligible for the digital reward due to the purchase of the asset from the merchant by the third party. It is to be understood that although the aforementioned exemplary hypothetical scenario in view of the embodiment of FIG. 6A is described in the context of an action or purchase made by a grocery shopper to acquire a good from a first-party system that may be a computer system such as a merchant system 106, where the purchase triggers a digital-asset reward from the digital-asset-provider system 104 such as a gaming-platform host, other exemplary hypothetical scenarios are also contemplated in which a virtual action or achievement made by a virtual gamer at a second-party system that may be a computer system such as a gaming-platform host or digital-asset-provider system 104 may trigger a physical-asset reward from a merchant system 106.

Furthermore, it is understood that the interfaces 185 and 186 may each be a respective access point interface (API) that also may be coupled to the at least one first-party system that may be a computer system such as a merchant system 106 and to the at least one second-party system that may be a computer system such as a digital-asset-provider-system or gaming-platform host 104. Such an API may be implemented as a conventional access point interface that serves as an access point to one or more networks operated by a third party separate from the network(s) operated by the merchant and the network(s) operated by the digital-asset provider. Although only one merchant system 106 and only one digital-asset-provider system 104 are explicitly shown in FIG. 6A, any number of merchant systems and digital asset provider systems can be connected to the respective APIs, in which each merchant system 106 corresponds to a different merchant and each digital-asset-provider system 104 corresponds to a different digital-asset provider.

FIG. 6B is another diagram of an exemplary system 610 including at least one first-party system that may be a computer system (e.g., a merchant system 106), at least one second-party system that may be a computer system (e.g., a digital-asset-provider system or gaming-platform host 104), and at least one computer circuit (e.g., an advertisement-and-reward generator 101) configured to determine whether a user transaction related to a physical or digital-asset event satisfies the parameters of an advertisement event. The exemplary system 610 of FIG. 6B may be generally configured to determine whether to match an asset of the first-party system with a reward of the second-party system (or an asset of the second-party system with a reward of the first-party system) and determine whether an action regarding the asset satisfies a condition for receiving the reward. The system 610 may be further configured to notify either or both of the first-party system and the second-party system that a patron or user of the system 610 (such as a grocery shopper or virtual gamer) is eligible for the reward.

The exemplary system 610 illustrated in FIG. 6B may achieve a similar functionality as the embodiment of FIG. 6A, with additional capability provided by the direct interfacing between the first-party system (e.g., a merchant system 106) and the second-party system (e.g., a digital-asset-provider system 104). In addition, the embodiment of FIG. 6B may include similar components, including a promotion-generating system 108 and verification system 110 of the at least one computer circuit (e.g., an advertisement and reward generator 101, for example, stand alone or included as part of a promotion-generating system 108).

As shown in the exemplary system 610 of FIG. 6B, each of the first-party system (e.g., a merchant system 106), at least one computer circuit (e.g., an advertisement-and-reward generator 101), and second-party system (e.g., a digital-asset-provider system such as a gaming-platform host 104) may include respective input/output ports connected by an interface such as a bus. For example, the first-party system 106 may include an input/output port 187 coupled to an input/output port 189 of the second-party system 104 via an interface 197. The interface 197 of the first-party system 106 and the second-party system 104 may be in further communication with input/output port 188 of the at least one computer circuit 101 via the interface 195. Alternatively, the interfaces 195 and 197 together can be a single interface.

Interfaces 195 and 197 each may be an access point interface (API) in communication with the at least one first-party system such as a merchant system 106 and the at least one second-party system such as a digital-asset-provider system such as a gaming-platform host 104. The API may be implemented as a conventional access point interface that serves as an access point to one or more networks operated by a third party separate from the network(s) operated by the merchant and the network(s) operated by the digital-asset provider. Although only one merchant system 106 and only one digital-asset-provider system 104 are explicitly shown in FIG. 6B, any number of merchant systems and digital-asset-provider systems can be connected to such APIs, in which each merchant system 106 corresponds to a different merchant and each digital asset provider system 104 corresponds to a different digital-asset provider.

FIGS. 6C-6D are a diagram of a system 600 including a verification system 110 configured to determine whether a patron transaction satisfies the criteria of an advertisement event 144, according to an embodiment. The system 600 illustrated in FIGS. 6C-6D can be implemented using the systems 100 and 400 described in the context of FIGS. 1 and 4, with reference numerals identical between FIGS. 1, 4, and 6 denoting similar components performing the same functionality in FIGS. 6C-6D, as described in FIGS. 1 and 4.

In system 600, a patron 180 (e.g., a person) uses his/her mobile device (smartphone, laptop, etc.) to access the merchant interface module 126 or app interface module 128. This way, the patron 180 can see the advertisement events 144 that are currently being promoted by the merchant or the digital-asset provider. For example, the advertisement events 144 may show up as a tab, window, or ‘pop-up’ on the website or app page associated with the merchant or digital-asset provider. In an embodiment, an advertisement event 144 may also be viewed by a patron while playing a virtual game, while visiting a virtual game store associated with a digital-asset-provider system 104, while reviewing a merchant loyalty application associated with a merchant system 106, and/or in any other suitable manner. Advertisement event 144 may be specific to each patron 180, depending on the criteria determined in the promotion module 130. For example, it may be possible to decrease, increase, modify, or entirely remove the advertisement event 114 for some patrons, based on the requirements of promotion module 130. For example, an advertisement event 144 for an 8-year-old child may be different in comparison to an advertisement event 144 for a 30-year-old adult. An advertisement event 144 for an 8-year-old child may pertain to a particular children's cereal, while an advertisement event 144 for a 30-year-old adult may pertain to a hair shampoo. An advertisement event 144 for an 8-year-old child may also differ in the frequency of the advertisement event 144, so that the frequency of the advertisement event can be increased or decreased in terms of how often the advertisement event 144 is promoted to the 8-year-old child. A frequency of an advertisement event 144 for a 30-year-old adult may also differ from the frequency of an advertisement event 144 for an 8-year-old child.

A merchant or digital-asset provider can utilize other promotional methods to make patrons 180 aware of the advertisement event 144, such as by sending an email associated with the patron 180. Even if the patron 180 is not aware of an advertisement event, a patron 180 may still qualify for a reward if the patron 180 completes the conditions of the advertisement event (e.g., by completing a qualified transaction under the terms of the advertisement event). For example, in a hypothetical scenario in which a patron 180 is not aware of an advertisement event but still qualifies for a reward, it may be possible that the patron 180 does not already have the associated virtual game installed on his/her mobile device (smartphone, laptop, etc.) or game console. In such a scenario, the merchant or digital-asset provider may notify the patron 180 that the patron 180 may install the associated virtual game and link it to the website or app page associated with the merchant or digital-asset provider to redeem the reward that was unknowingly earned.

When the patron 180 makes a transaction, a transaction receipt 171 is sent to the point of service (POS) terminal 190 of the merchant system 106. The transaction receipt 171 includes information such as the customer ID 170 associated with the patron 180, and a transaction ID 173 that includes characteristics of each asset 172, 174, 176 purchased by the patron 180. The characteristics of the assets 172, 174, 176 are then stored in physical asset database 122 and the customer ID 170 is stored in a merchant user database 120 as a user ID 146 (which can be the same database as, or a different database from, the physical asset database 122). The customer ID 170 and transaction ID 173 information can then be embedded in a message that is transmitted from the merchant system 106 to API 102. The message includes the user ID 146 associated with the customer ID 170 and the transaction data 148 extracted from the transaction ID 173. API 102 provides the customer information with consumer ID 150 corresponding to the customer ID 170 and the transaction information including the assets 152, 154, 158 purchased by the customer to verification system 110.

Verification system 110 is configured to determine whether the transaction completed by the patron 180 satisfies the conditions of any currently pending advertisement events 144 generated for the merchant system 106. For example, verification system 110 includes a redemption engine 156 configured to receive information about the asset(s) 152, 154, 158 purchased by the patron 180 and to determine whether one or more of the assets 152, 154, 158 correspond to a matched asset pairing with one or more digital assets, and if the patron met any user criteria based on their metadata, history, or status. Redemption engine 156 also determines whether the transaction satisfies other required parameters, such as whether the transaction was completed within the timeframe (e.g., verifying that a transaction was made after 5:00 PM for a promotion that was active between the hours of 4:00 PM and 11:59 PM), or whether the patron 180 spent a sufficient amount of money, or whether the patron 180 bought a sufficient number of qualified assets, as some examples. Redemption engine 156 may evaluate a user's promotion engagement information or similar history metadata received from the API 102. For example, part of a promotion could include bonus rewards after redeeming five promotional rewards within a week. Another example could be receiving increasing valuable promotion offers for each day the patron, or someone associated with the patron (e.g., a parent) visits a store and purchases a physical asset or otherwise satisfies the conditions of a pending advertisement event 144. Part of a promotion may also include receiving offers for greater promotions for logging into a mobile game and playing each day. Promotions may also include guarantees for a minimum reward for recurring participation and engagement with promotions created by the promotion-generating system 108.

For any assets purchased by the patron 180 that do not have matched asset pairings with a digital asset, or for those assets that do have matched asset pairings but do not satisfy all the parameters of the advertisement event 144, redemption engine 156 discards the assets and lists only the assets that satisfy all parameters of the advertisement event 144 and hence, qualify for a digital-asset reward.

Upon determining the one or more assets that satisfy all parameters of an advertisement event 144, the redemption engine 156 then correlates the assets with at least one digital-asset reward. For example, for each qualified asset 152, redemption engine 156 looks up the matched digital asset(s) that correspond to the respective asset 152 and generates a redemption receipt 163 that lists the digital assets 162, 164, 166 that are earned by the patron 180. The redemption receipt 163 also includes the user ID 160 that corresponds to the patron 180 so that the digital asset provider(s) can determine that the digital asset(s) should be issued to the user profile of the virtual game where the user profile corresponds to the patron 180.

It is also possible that patron 180 and person associated with user ID 160 are not the same person and that a many-to-one relationship (N:1 relationship) exists, where a system limit may enforce a limit on the maximum number of relationships. In other words, multiple users in a merchant database 120 can be associated with a single user in app user database 116. Consider the example where in a family, a child might play a popular mobile game but doesn't go grocery shopping, nor has a reward account at a grocery store. A N:1 relationship between consumer ID 150 (the family shopper) and user ID 160 (the child gamer) allows the system to reward the child's gaming account for purchases that his parents, grandparents, siblings, etc. make from linking their consumer ID 150 with the child's user ID 160 for a specific game account. In some embodiments, only one user (game account) ID may be the beneficiary of a single transaction. In other embodiments, more than one user (game account) ID 160 may be linked to a consumer ID 150, so that more than one user (game account) ID 160 may be the beneficiary of a single transaction. For example, in a family with a father of four children, a many-to-one relationship (N:1 relationship) may exist between the consumer ID 150 of the father (the family shopper) that is linked to the user IDs 160 (game accounts) of the four children. In such an example, the father may be a loyalty reward member of a particular grocery store, so that when the father makes a purchase at the grocery store, the system rewards one or more of the user IDs 160 (game accounts) of the four children for the purchase by consumer ID 150 of the father.

Verification system 110 generates a reward message 168 that is transmitted to the digital-asset-provider system 104, e.g., to the app interface module 128, directing the digital-asset-provider to issue the digital asset(s) (e.g., reward(s) to the patron 180. In some embodiments, the reward message 168 is also transmitted to the merchant system 106, e.g., to the merchant interface module 126, so that the merchant is also aware of the advertisement events 144 that the patron 180 successfully completed or with which the patron otherwise complied. The patron 180 can then claim the digital assets by accessing the virtual game through app interface module 128 and obtaining the digital assets given by the digital asset provider as a reward in response to completing the advertisement event 144. In some embodiments, the patron 180 is notified by the digital-asset provider that he/she successfully completed an advertisement event 144 and has earned the listed assets determined by redemption engine 156. Additionally, the digital-asset provider or the merchant may ask the patron 180 to send feedback or to review products, services, or other advertisement events 144, and, in exchange, may grant additional asset rewards for doing so.

In some embodiments, the verification system 110 and the promotion-generating system 108 exchange data. In such embodiments, the verification system 110 and the promotion-generating system 108 may together comprise an advertisement and reward generator 101. When generating advertisement events, promotion-generating system 108 can gather information on what recent or frequent physical or digital assets have been issued as rewards as a factor in determining what physical or digital assets could be promoted in subsequent advertisement events. Conversely, verification system 110 can review parameters of active advertisement events stored in databases in promotion-generating system 108 in determining whether a given transaction receipt 171 has satisfied the parameters of an active advertisement event.

In some embodiments, providers of physical goods or services within the merchant system 106 may be connected or linked to game apps within the digital-asset-provider system 104 via a respective code issued by a game app. For example, when a grocery shopper purchases physical assets at a grocery store, the shopper may provide or enter a code at the grocery store to link an account within the merchant system 106 to an associated account in the digital asset provider system 104. Entering the code at the grocery store may link a user ID (in the merchant system 106) and a game ID (in the digital-asset-provider system 104). In an embodiment, a number of game IDs that may be linked to a user ID (and a number of user IDs that may be linked to a game ID) may be limited for purposes of issuing a reward based upon engagement in a promotion.

System 600 may also include a blockchain ledger 112 or other type of record keeping or database systems that may be coupled to API 102 to provide an additional database for backend storage 109. Any previously generated advertisement events 144, user transactions, and reward information may be stored in blockchain ledger 112 or in the additional database with backend storage 109 and updated as new advertisement events 144, transactions, and rewards are generated. For example, if promotion-generating system 108 generates a new advertisement event 144 or modifies an existing advertisement event, the advertisement event 144 information, including parameters of the advertisement event, are sent to API 102 and recorded in blockchain ledger 112. Also, when a patron 180 completes a transaction or is issued an asset reward, verification system 110 may send the reward information to API 102 for recording in blockchain ledger 112, which may record when a patron 180 earns and/or claims a reward. As an example, blockchain ledger 112 can record any of the following parameters: merchant ID, digital-asset provider ID, user ID and metadata, transaction ID and metadata, physical asset ID and metadata, digital asset ID and metadata.

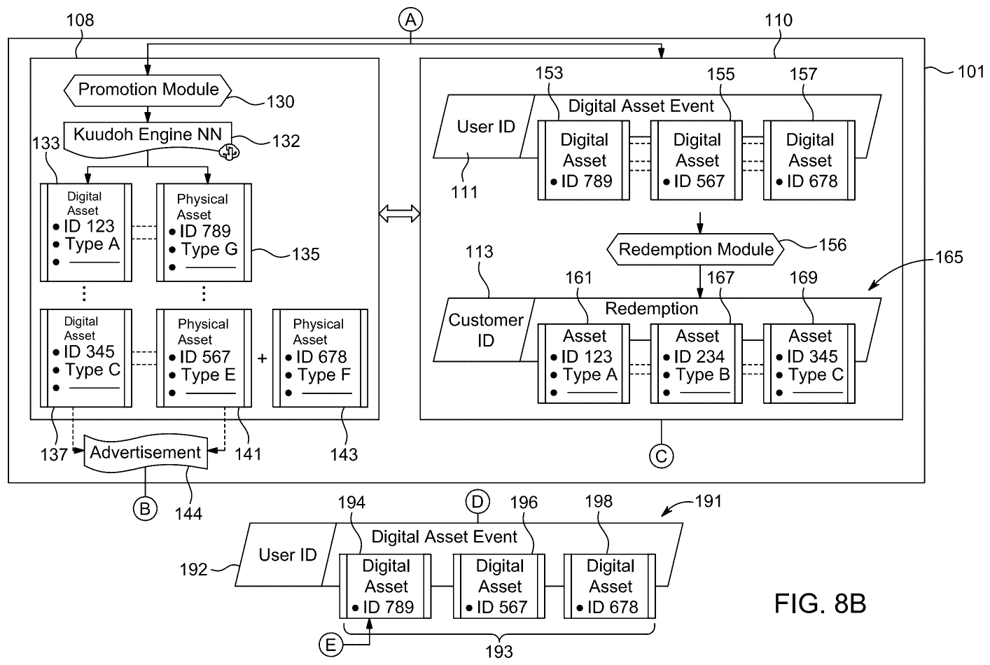

While system 600 has been described in the context of redeeming digital assets for physical assets purchased by a patron 180 (or by someone associated with the patron), in some embodiments (such as the embodiment of FIGS. 8A-8B) system 800 is configured to issue physical assets to a patron 180 based on purchasing, or otherwise earning, digital assets. In this embodiment, promotion-generating system 108 is configured to generate an advertisement event 144 that is displayed on the app interface module 128 of the digital-asset provider system 104. A patron 180 then performs an action such as completing an achievement in the virtual game or buying a certain type of asset, and a record of the action is sent to verification system 110. Upon determining that the action satisfies the parameters of an advertisement event 144, verification system 110 determines one or more physical assets that are matched with the action in the virtual game, which can be claimed by the patron 180 (or by someone corresponding to the patron) as previously described.

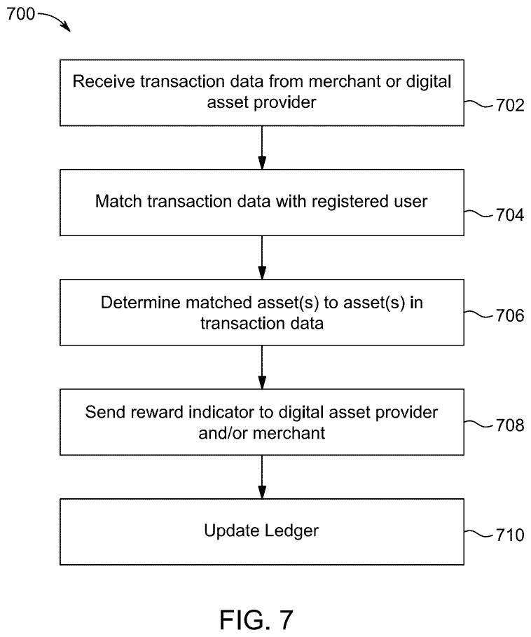

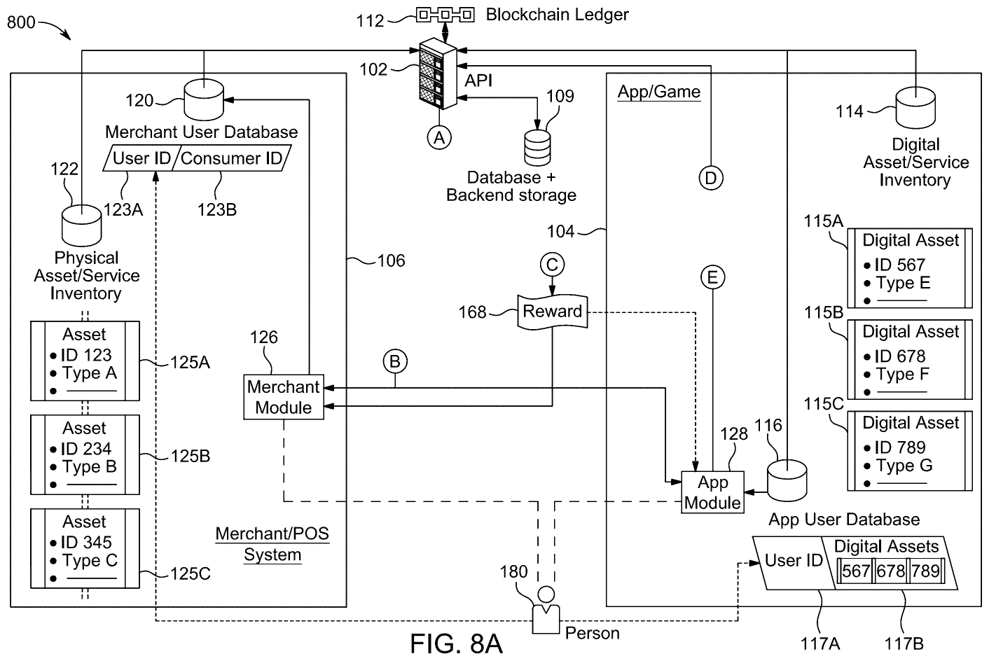

FIG. 7 is a flow diagram 700 of an exemplary method for determining a reward for a patron (or someone corresponding to the patron such as a parent, sibling, grandparent, uncle/aunt, and/or friend of the patron) that transacted with either the merchant or digital-asset provider. Method 700 may be implemented as described in the context of system 600 and, e.g., based on the functions described in connection with verification system 110.

Method 700 includes the system 600, which receives transaction data from a merchant or digital-asset provider at step 702. For example, when a patron (or someone corresponding to the patron) purchases a physical asset, merchant system 106 provides data on the user ID that corresponds to the patron as well as the data on the physical assets or services purchased by the patron. Alternatively, a digital asset provider system 104 provides data on the user ID and the digital assets earned or purchased by the patron in connection with a virtual game managed by the digital asset provider.

At step 704, the system 600 matches the received transaction data with a registered user based on the stored user ID information. The transaction data may be received in the form of a transaction receipt 171 that is correlated to a particular customer ID. The system 600 then matches the transaction data to a specific patron by comparing the customer ID with a user ID stored in the database or the blockchain ledger 112, or the user may be identified based on the transaction receipt 171 alone.

The system 600 proceeds to step 706 and determines the matched asset(s) that are correlated with the asset(s) in the transaction data. In one embodiment, the system 600 identifies each physical or digital asset acquired by the patron from the transaction and determines, e.g., by looking up in a database managed by promotion-generating system 108, which asset(s) were matched with the assets listed in the transaction data. As an example, if a patron purchases a bag of chips and that bag of chips is matched with a set of currency in a virtual game, then the system 600 identifies the bag of chips from the transaction data and looks in the database to determine the matched set of currency.

From step 706, system 600 proceeds to step 708 and sends a message to the digital-asset provider and/or to the merchant with an indication of the reward to be issued to the patron. In some embodiments, when a digital asset is earned, the system 600 sends a reward indicator to both the digital-asset provider directing the digital-asset provider to issue the earned digital asset to the patron, and to the merchant to notify the merchant that the patron completed a promotion with the physical asset. The patron can then claim his/her digital-asset(s) reward by interfacing with the digital-asset provider, such as by accessing the virtual game on his/her mobile device. If the reward is a physical asset, then the system 600 can send a reward indicator to the merchant informing the merchant that the patron is entitled to the reward, and to the digital-asset provider notifying the digital-asset provider that the patron completed a promotion related to the merchant and that earned, as a reward, a digital asset.

The system 600 then proceeds from step 708 to step 710 and updates the ledger 112 with the transaction data and the reward indicators that were sent to the digital-asset provider and/or merchant.

While system 600 has been described in the context of redeeming digital assets for physical assets purchased by a patron 180 (or someone else related, or otherwise corresponding, to the patron), in some embodiments, such as the embodiment corresponding to the system 800 illustrated in FIGS. 8A-8B, the system 800 is further configured to issue physical assets to a patron 180 based on the patron (or someone else related, or otherwise corresponding to) purchasing digital assets, digital achievements, or other video-game related item, in a video game, for example. In the embodiment of FIGS. 8A-8B, promotion-generating system 108 is configured to generate an advertisement event 144 that is displayed on the app interface module 128 of the digital-asset-provider system 104 (e.g., in a virtual game). A patron 180 then performs an action such as completing an achievement in the virtual game or buying a certain type of digital asset in the game, and a record of the digital action is sent to verification system 110. Upon determining that the digital action satisfies the parameters of an advertisement event 144, verification system 110 determines one or more physical assets that are matched with the digital action in the virtual game, which can be claimed by the patron 180 as previously described.

FIGS. 8A-8B are a diagram of a system 800 including a verification system 110 configured to determine whether a patron's digital transaction or digital achievement satisfies the criteria of an advertisement event 144. The system 800 illustrated in FIGS. 8A-8B can be implemented using the systems 100, 400 described in the context of FIGS. 1 and 4, with reference numerals identical between FIGS. 1, 4, and 6 denoting similar components performing the same functionality in FIGS. 8A-8B as described in FIGS. 1 and 4. And similar to the system 600 of FIGS. 6C-6D, the system 800 of FIGS. 8A-8B may include at least one first-party system that may be a computer system such as a merchant system 106 and at least one second-party system that may be a computer system such as a digital-asset-provider system such as a gaming-platform host 104.

As shown in FIGS. 8A-8B with promotion-generating system 108, the evaluation engine 132 generates an output indicative of at least one paired digital asset 133 with at least one physical asset 135. In some embodiments, a digital asset 137 is paired to multiple physical assets 141 and 143. Each digital asset 133 and physical asset 135 includes one or more characteristics such as the identifier of the digital/physical asset and the type of asset. For example, a physical asset in a grocery store may include an identifier used by the store to categorize inventory, whereas a digital-asset identifier may correspond to a code segment or a displayed item used in the virtual game.

In system 800, a patron 180 uses his/her mobile device (smartphone, laptop, etc.) to access the merchant interface module 126 or app interface module 128. This way, the patron 180 can see the advertisement events 144 that are currently being promoted by the merchant or the digital asset provider. For example, the advertisement events 144 may show up as a tab, window, or ‘pop-up’ on the website or app page associated with the merchant or digital asset provider. Advertisement event 144 may be specific to each patron 180, depending on the criteria determined in promotion module 130. For example, it may be possible to decrease, increase, or modify the frequency of the advertisement event, or entirely remove advertisement event 144 for some patrons, based on the requirements that the promotion module 130 sets. For example, an advertisement event 144 for an 8-year-old child may be different in comparison to an advertisement event 144 for a 30-year-old adult. An advertisement event 144 for an 8-year-old child may pertain to a particular children's cereal, while an advertisement event 144 for a 30-year-old adult may pertain to a hair shampoo. An advertisement event 144 for an 8-year-old child may also differ in the frequency of the advertisement event 144, so that the frequency of the advertisement event can be increased or decreased in terms of how often the advertisement event 144 is promoted to the 8-year-old child. A frequency of an advertisement event 144 for a 30-year-old adult may also differ from the frequency of an advertisement event 144 for an 8-year-old child.

A merchant or digital-asset provider can utilize other promotional methods to make patrons 180 aware of the advertisement event 144, such as by sending an email associated with the patron 180. Even if the patron 180 is not aware of an advertisement event, a patron 180 may still qualify for a reward if the patron 180 completes the conditions of the advertisement event (e.g., by completing a qualified digital transaction or digital achievement under the terms of the advertisement event). For example, in a hypothetical scenario in which a patron 180 (or another person related, or otherwise corresponding, to the patron) is not aware of an advertisement event but still qualifies for a reward, it may be possible that the patron 180 does not already have the associated virtual game installed on his/her mobile device (smartphone, laptop, etc.) or game console. In such a scenario, the merchant or digital asset provider may notify the patron 180 that the patron may install the associated virtual game and link it to the website or app page associated with the merchant or digital-asset provider to redeem the reward that the patron unknowingly earned.

When the patron 180 makes a digital transaction or accomplishes a digital achievement of some form in a video game or other virtual game, a transaction receipt 191 is sent to the app interface module 128 of the digital-asset-provider system 104. The transaction receipt 191 includes information such as the customer or user ID 192 associated with the patron 180, and a transaction ID 193 that includes characteristics of each digital asset (or digital achievement) 194, 196, 198 purchased or achieved by the patron 180. The characteristics of the assets 194, 196, 198 are then stored in digital asset database 114 and the user ID 192 is stored in user database 116 as a user ID 117A (which also can be the same database as digital asset database 114). The user ID 192 and transaction ID 193 information then can be embedded in a message that is transmitted from the digital-asset-provider system 104 to API 102. The message includes the user ID 117A associated with the user ID 192 and asset characteristics 117B extracted from the transaction ID 193. API 102 provides, to the verification system 110, the customer information with user ID 111 corresponding to the user ID 192 and the transaction information including the digital assets 153, 155, 157 purchased (or achieved) by the customer.

Verification system 110 is configured to determine whether the transaction completed by the patron 180 satisfies the conditions of any currently pending advertisement events 144 generated for the digital-asset-provider system 104. Verification system 110 includes the redemption engine 156 configured to receive information about the digital asset(s) 153, 155, 157 purchased or achieved by the patron 180 (or corresponding person) and determine whether one or more of the digital assets 153, 155, 157 correspond to a matched asset pairing with one or more physical assets, and if the patron met any user criteria based on his metadata, history, or status. Redemption engine 156 also determines whether the transaction satisfies other required parameters, such as whether the transaction was completed within the timeframe (e.g., verifying that a transaction was made after 5:00 PM for a promotion that was active between the hours of 4:00 PM and 11:59 PM), or whether the patron 180 spent a sufficient amount of money, or whether the patron 180 bought a sufficient number of qualified digital assets, or achieved a certain level or status in a video game, as some examples. Redemption engine 156 may evaluate a user's promotion engagement information or similar history metadata received from API 102. For example, part of a promotion could include bonus rewards after redeeming five promotional rewards within a week. Another example could be receiving increasing valuable promotion offers for each day the patron 180 (or another person corresponding to the patron) visits a store and purchases a digital asset or satisfies the conditions of a pending advertisement event 144. Part of a promotion may also include receiving offers for greater promotions for logging into a mobile game and playing each day. Promotions may also include guarantees for a minimum reward for recurring participation and engagement with promotions created by the promotion-generating system 108.

For any digital assets purchased or achieved by the patron 180 that do not have matched asset pairings with a physical asset, or for those digital assets that do have matched asset pairings but do not satisfy all the parameters of the advertisement event 144, redemption engine 156 discards the digital assets and lists only the digital assets that satisfy all parameters of the advertisement event 144 and hence, qualify for a physical asset reward.

Upon determining the digital assets that satisfy all parameters of an advertisement event 144, redemption engine 156 then correlates the digital assets with at least one physical asset reward. For example, for each qualified digital asset 153, redemption engine 156 looks up the matched physical asset(s) that correspond(s) to the respective digital asset 153 and generates a redemption receipt 165 that lists the physical assets 161, 167, 169 that are earned by the patron 180. The redemption receipt 165 also includes the customer ID 113 that corresponds to the patron 180 so that the physical asset provider(s) can determine that the physical asset(s) should be issued to the user profile (e.g., of the patron or of someone corresponding the patron such as a parent or spouse) in the merchant system 106 that corresponds to the patron 180.

It is also possible that patron 180 and customer ID 113 are not the same person and that a many-to-one relationship (N:1 relationship) exists, where a system limit may enforce a limit on the maximum number of relationships. In other words, multiple users in a merchant database 120 can be associated with a single user in a digital-asset-provider system 104 user database 116. Consider the example where in a family, a gamer in the family might play a popular mobile game but does not go grocery shopping, nor has a reward account at a grocery store. A 1:N relationship between user ID 111 (the gamer) and customer ID 113 (the family shoppers: parents, grandparents, siblings, etc.) allows the system to reward the family shopper account of the parents, grandparents, siblings, etc. in the family for the digital asset events of the family gamer from linking the gamer's user ID 111 with the parents', grandparents', and/or siblings' customer ID 113 accounts. In some embodiments, only one family shopper account can be the beneficiary of a single digital transaction by the gamer. In other embodiments, more than one family shopper customer ID 113 may be linked to a gamer's user ID 111, so that more than one family shopper customer ID 113 may be the beneficiary of a reward for a single digital transaction. For example, in a family with four grandparents and one grandchild, a many-to-one relationship (N:1 relationship) may exist between the customer IDs 113 of the four grandparents (the family shoppers) linked to the user ID 160 (game accounts) of the grandchild. In such an example, when the user ID 111 (game account) of the grandchild participates in a digital asset event, the system rewards the customer IDs 113 of the four grandparents (the family shoppers) for the digital asset event of the user ID 111 (game account) of the grandchild.

Verification system 110 generates a reward message 168 that is transmitted to the merchant system 106, e.g., to the merchant interface module 126, directing the merchant system 106 to issue the one or more physical assets to the patron 180 (or corresponding other person). In some embodiments, the reward message 168 is also transmitted to the digital-asset-provider system 104, e.g., to the app interface module 128, so that the digital-asset-provider system 104 is also aware of the advertisement events 144 which the patron 180 successfully completed. The patron 180 then can claim the physical assets by accessing the merchant interface module 126 and obtaining the physical assets (e.g., by going to the merchant's brick-and-mortar place of business, or by delivery) given by the merchant system 106 in response to completing the advertisement event 144. In some embodiments, the patron 180 is notified by the merchant system 106 that he/she successfully completed an advertisement event 144 and has earned the listed one or more assets determined by the redemption engine 156. Additionally, the digital-asset provider or the merchant may ask the patron 180 to send feedback or to review products, services, and/or other advertisement events 144, and, in exchange, may grant additional asset rewards for doing so.

In some embodiments, the verification system 110 and the promotion-generating system 108 exchange data. In such embodiments, the verification system 110 and the promotion-generating system 108 may together comprise an advertisement and reward generator 101. When generating advertisement events, promotion-generating system 108 can gather information on what recent or frequent physical or digital assets have been issued as rewards as a factor in determining what physical or digital assets could be promoted in subsequent advertisement events. Conversely, verification system 110 can review parameters of active advertisement events stored in databases in promotion-generating system 108 in determining whether a given transaction receipt 191 has satisfied the parameters of an active advertisement event.

System 800 also may include a blockchain ledger 112 or other type of record keeping or database systems that may be coupled to the API 102 to provide an additional database for backend storage 109. Any previously generated advertisement events 144, user transactions, and reward information may be stored in blockchain ledger 112 or in the additional database with backend storage 109 and updated as new advertisement events 144, transactions, and/or rewards are generated. For example, if promotion-generating system 108 generates a new advertisement event 144 or modifies an existing event, the advertisement event 144 information, including parameters of the advertisement event, are sent to API 102 and recorded in blockchain ledger 112. Also, when a patron 180 completes a transaction or is issued an asset reward, verification system 110 may send the reward information to API 102 for recording in blockchain ledger 112, which may record when a patron 180 claims a reward. As an example, blockchain ledger 112 can record any of the following parameters: merchant ID, digital asset provider ID, user ID and metadata, transaction ID and metadata, physical asset ID and metadata, and/or digital asset ID and metadata.

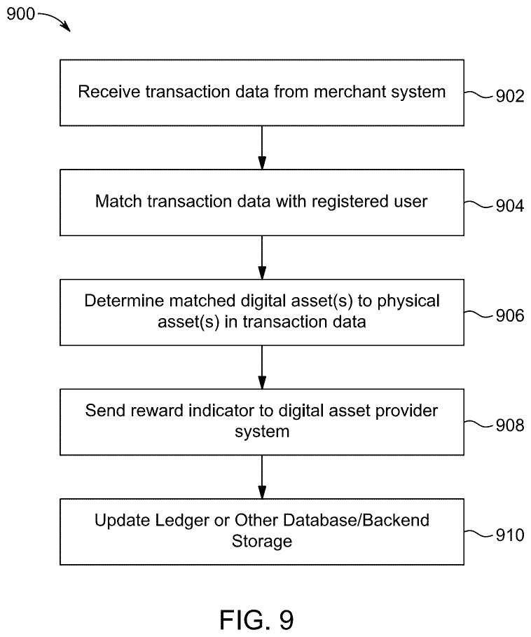

FIG. 9 is a flow diagram 900 of an exemplary method for determining a reward for a patron that transacted with either the merchant or digital asset provider, according to an embodiment. Method 900 may be implemented as described by, or otherwise in the context of, the system 600 and/or the system 800 and, e.g., based on the functions described in connection with verification system 110, and more generally in the context of the functions described in connection with the advertisement and reward generator 101 comprising both the verification system 110 and the promotion-generating system 108. For clarity, the method 900 is described as being performed by the system 600, it being understood that the method also can be performed by the system 800 or any of the other suitable subsystems and components as described herein.

The system 600 receives transaction data from a merchant at step 902. For example, when a patron purchases a physical asset, merchant system 106 provides, to the system 600, data on the user ID that corresponds to the patron as well as the data on the physical assets and/or services purchased by the patron.

At step 904, the system 600 matches the received transaction data with a registered user based on the stored user ID information. The system 600 may receive the transaction data in the form of a transaction receipt 171 that is correlated to a particular customer ID. The system 600 then matches the transaction data to a specific patron by comparing the customer ID with a user ID stored in the database (e.g., data base 114, 120, and/or 122) or the blockchain ledger 112 or other database/backend storage 109 that is coupled to the API 102, or the user may be identified based on the transaction receipt 171 alone.

The system 600 proceeds to step 906 and determines the matched digital asset(s) that are correlated with the physical asset(s) in the transaction data. In one embodiment, the system 600 identifies each physical asset acquired by the patron from the transaction and determines, e.g., by looking up in a database managed by promotion-generating system 108, which digital asset(s) were matched with the physical assets listed in the transaction data. As an example, if a patron purchases a bag of chips and that bag of chips is matched with a set of currency in a virtual game, then the system 600 identifies the bag of chips from the transaction data and looks in the database to determine that the set of currency is matched to the bag of chips.

With respect to determining the matched digital asset(s) that are correlated with the physical asset(s) in the transaction data at step 906, the verification system 110 and the promotion-generating system 108 of the system 600 may exchange data to identify the matched digital asset(s). As aforementioned, an advertisement and reward generator 101 may include both the verification system 110 and the promotion-generating system 108. The matched digital asset(s) may therefore be determined within and based upon information exchanged within the advertisement and reward generator 101. For example, and in the context of the system 600 illustrated in FIGS. 6C-6D and the flow diagram 900 of FIG. 9, while generating advertisement events, promotion-generating system 108 can gather information on what recent or frequent digital assets have been issued as rewards in response to purchases of physical assets, as a factor in determining what physical assets could be promoted in subsequent advertisement events. Conversely, the verification system 110 can review parameters of active advertisement events stored in databases in promotion-generating system 108 in determining whether a given transaction receipt 171 has satisfied the parameters of an active advertisement event.

From step 906, the system 600 proceeds to step 908 and sends a message to the digital-asset provider and/or to the merchant with an indication of the digital reward to be issued to the patron. In some embodiments, when a digital asset is earned, the system 600 sends a reward indicator to both the digital-asset provider directing the digital-asset provider to issue the earned digital asset to the patron, and to the merchant to notify the merchant that the patron completed a promotion regarding the physical asset. The patron can then claim his/her digital assets by interfacing with the digital-asset provider, such as by accessing the virtual game on his/her mobile device.

The system 600 can proceed from step 908 to step 910 and update the ledger 112 or other database/backend storage 109 that is coupled to the API 102 with the transaction data and the reward indicators that were sent to the digital-asset provider and/or merchant.

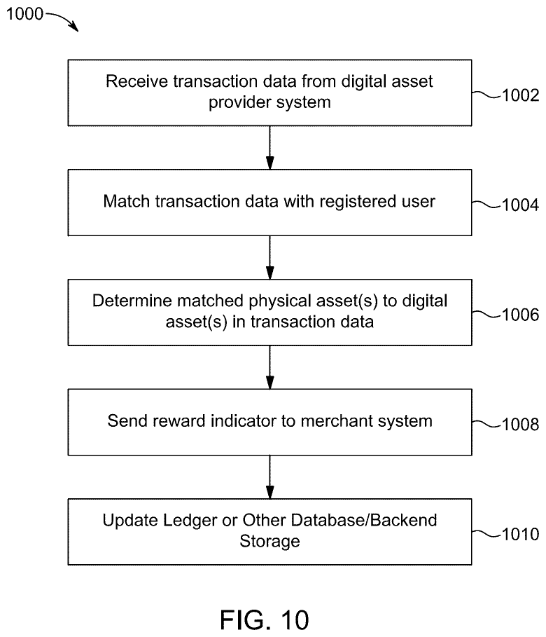

FIG. 10 is a flow diagram 1000 of an exemplary method for determining a reward for a patron that transacted with a digital asset provider. Method 1000 may be implemented as described in the context of system 800 and, e.g., based on the functions described in connection with verification system 110, and more generally in the context of the functions described in connection with the advertisement and reward generator 101 comprising both the verification system 110 and the promotion-generating system 108. For clarity, the method 1000 is described as being performed by the system 800, it being understood that the method also can be performed by the system 600 or any of the other suitable subsystems and components as described herein.

The system 800 receives transaction data from a digital-asset provider at step 1002. For example, when a patron purchases or achieves a digital asset in a virtual game, digital-asset provider system 104 provides data on the user ID that corresponds to the patron as well as the data on the digital asset(s) purchased or achieved by the patron.

At step 1004, the system 800 matches the received transaction data with a registered user based on the stored user ID information. The system 800 may receive the transaction data in the form of a transaction receipt 191 that is correlated to a particular customer ID. The system 800 then matches the transaction data to a specific patron by comparing the customer ID with a user ID stored in the database (e.g., database 114, 120, and/or 122) or the blockchain ledger 112 or other database/backend storage 109 that is coupled to the API 102, or the system 800 may identify the user based on the transaction receipt 191 alone.

The system 800 proceeds to step 1006 and determines the matched physical asset(s) that are correlated with the digital asset(s) in the transaction data. In one embodiment, the system 800 identifies each digital asset acquired or achieved by the patron from the transaction and determines, e.g., by looking up in a database managed by promotion-generating system 108, which physical asset(s) were matched with the digital asset(s) listed in the transaction data. As an example, if a patron achieves a particular level in a virtual game and that digital achievement is matched with bag of chips sold by a merchant, then the system 800 identifies that digital achievement from the transaction data and looks in the database to determine that the digital achievement is matched to a bag of chips sold by the merchant.

With respect to determining the matched physical asset(s) that are correlated with the digital asset(s) in the transaction data at step 1006, the verification system 110 and the promotion-generating system 108 may exchange data to identify the matched physical asset(s). As aforementioned, an advertisement and reward generator 101 may include both the verification system 110 and the promotion-generating system 108. The system 800, therefore, may determine and/or identify the matched physical asset(s) within and based upon information exchanged within the advertisement and reward generator 101. For example, and in the context of the system illustrated in FIGS. 8A-8B and the flow diagram of FIG. 10, while generating advertisement events, promotion-generating system 108 can gather information on what recent or frequent physical assets have been issued as rewards in response to purchases or achievements of digital assets, as a factor in determining what digital assets could be promoted in subsequent advertisement events. Conversely, verification system 110 can review parameters of active advertisement events stored in databases in promotion-generating system 108 in determining whether a given transaction receipt 191 has satisfied the parameters of an active advertisement event.

From step 1006, the system 800 proceeds to step 1008 and sends a message to the merchant and/or to the digital asset provider with an indication of the physical reward to be issued to the patron. In some embodiments, when a physical asset is awarded based upon a digital purchase or digital achievement, the system 800 sends a reward indicator to both the physical-asset provider directing the physical-asset provider to issue the earned physical asset to the patron, and to the digital-asset provider to notify the digital-asset provider that the patron completed a promotion with, or otherwise regarding, the digital asset. The patron can then claim his/her physical assets by interfacing with the merchant, such as by accessing the merchant system and visiting the merchant's physical location or claiming the physical assets by mail or other delivery method.

The system 800 can proceed from step 1008 to step 1010 and update the ledger 112 or other database/backend storage 109 that is coupled to the API 102 with the transaction data and the reward indicators that were sent to the merchant and/or digital asset provider.

Referring to FIGS. 1-10, it is contemplated that any of the functions, operations, or tasks described herein can be performed in software, firmware, and/or hardware (e.g., hardwired circuitry, field-programmable gate array (FPGA)), and/or any combination or sub combination thereof.

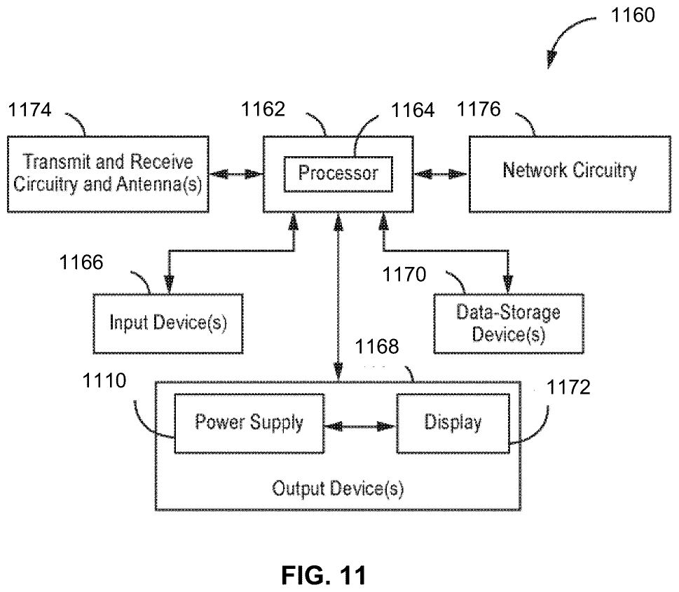

FIG. 11 is a block diagram of a hardware system 1160 that includes circuitry and electronic devices and other electronic apparati on which one or more of the systems (e.g., system 108, system 110, system 600, system 800), subsystems, and components described herein can be instantiated or otherwise implemented, and on which program instructions, firmware, and configuration data streams (e.g., for configuring an FPGA) can be executed or otherwise implemented. For example, the hardware system 1160 can include, or otherwise can be, one or more smart phones, laptop computers, tablet computers, desktop computers, and/or other computing devices. The hardware system 1160 includes computing circuitry configured to run one or more software applications (Apps), one or more display devices configured to display pages and other information generated by the one or more Apps or other display generators, one or more memory circuits or devices configured to store program instructions such as program code that constitutes one or more Apps, and communication circuitry configured to allow communications between the components of the hardware system directly or via one or more communications networks (e.g., the cloud) and one or more databases. Examples of suitable communication networks include a cellular network, a wireless local-area network (LAN), and the internet. And examples of suitable databases include merchant databases, gaming-platform databases, and any other suitable databases. Alternatively, some or all of the devices and other circuitry of the hardware system 1160 can be configured to communicate with each other directly, for example, via one or more wireless connections such as a WiFi® or a BlueTooth® wireless connection. For security, communications between any of the patrons and merchant and/or digital-asset providers can be encrypted one or both ways. Furthermore, data stored onboard any of the devices or on the database can be encrypted for a further level of security.

Still referring to FIG. 11, the hardware system 1160 can be configured to implement the hardware systems, subsystems, and components described herein, and to download, to store, to install, and to run an embodiment of the above-described software applications accessible to patrons of the merchant and/or digital-asset provider, according to an embodiment. Examples of the hardware system 1160 include, but are not limited to, a smart phone, a pad computer, a tablet computer, a laptop computer, a personal computer, a local-server computer, and a cloud-server computer.

The hardware system 1160 includes computing circuitry 1162, which includes a processor 1164; the hardware system also includes at least one input device 1166, at least one output device 1168, at least one data-storage device 1170, at least one transmit-and-receive circuitry 1174 including at least one antenna, and network circuitry 1176.

The at least one output device 1168 includes a display 1172 and a power supply 1110, which powers the display. For example, the display 1172 may be a liquid-crystal display (LCD) for a smart phone. Although not shown in FIG. 11, the device 1160 can include one or more additional power supplies to power components and circuits of the device other than the display 1172, or the power supply 1110 can be configured to power the other components and circuits in addition to the display.

The processor 1164 can be, for example, a microprocessor or microcontroller, and is configured to execute program instructions that form, or that are otherwise part of, the software applications accessible to patrons of the merchant and/or digital-asset provider (also referred to herein as “the Apps”). For example, while executing, and in response to, the Apps' program instructions, the processor 1164 is configured to perform, and does perform, some or all of the above-described functions and operations attributed to the software applications either alone or in cooperation with other circuitry and components of the hardware system 1160.

The input device (e.g., a displayed or physical keypad or keyboard, a voice-command component, a mouse) 1166 allows the providing of data, programming, and commands to the computing circuitry 1162.

The display 1172 (and any other included output device 1168) allows the computing circuitry 1162 to provide data in a form (e.g., still image, video, menu, web or other page such as a data-entry or data-display page) perceivable by a human operator such as a merchant, digital asset provider, patrons of the merchant and/or digital asset provider, such as gamers and customers, and family members and other associates of the patrons. In an embodiment, the display 1172 is a touch screen configured to allow a user to select an icon or another item displayed on the screen by touching a portion of the screen over the displayed icon or other item.

The data-storage device (e.g., hard-disk drive, optical drive, and solid-state memory such as a flash drive, RAM, EPROM, and EEPROM) 1170 allows for the storage of, e.g., programs and data such as an embodiment of the above-described software applications accessible to patrons of the merchant and/or digital-asset provider and data acquired by, generated by, and otherwise related to the software applications.

The transmit and receive circuitry 1174 (also called a transceiver) includes one or more antennas, and is configured to transmit data from the hardware system 1160 to one or more remote devices or components of the hardware system 1160 that are remote from one another (e.g., a merchant or digital-asset provider server on which resides a merchant or digital-asset provider database that stores information about customers of the merchant or gamers associated with the digital-asset provider if these servers are remote from other each other or other components of the hardware system) or other remote destinations, and to receive data from one or more remote devices (e.g., the aforementioned merchant or digital-asset provider server) or other remote sources. The transmit and receive circuitry 1174 is configured to communicate with one or more such remote devices using one or more suitable protocols such as a cellular-network protocol (e.g., 4G, 5G), Bluetooth®, and WiFi®, and may include a respective antenna for each protocol for which the device 1160 is configured. For example, in an embodiment the device 1160 is configured to download the software applications accessible to patrons of the merchant and/or digital-asset provider, and to transmit and to receive data related to the software application, via the transmit and receive circuitry 1174.

And the network circuitry 1176 is configured to allow the hardware system 1160 to communicate with remote devices, or to allow components of the hardware system remote from one another to communicate, over one or more networks, such as a cellular network and a local-area network (LAN). For example, in an embodiment, the network circuitry 1176 includes an input port (e.g., a USB port) that is configured to allow the computing circuitry 1162 and other components of the device 1160 to communicate with another device over a conductive cable such as an Ethernet cable. Or the network circuitry 1176 can cooperate with the transmit and receive circuitry 1174 to allow the computing circuitry 1162 and other components of the device 1160 to communicate with one or more other devices over a wireless channel. For example, in an embodiment the device 1160 is configured to download the software applications accessible to patrons of the merchant and/or digital-asset provider, and to transmit and to receive data related to the software application, via the network circuitry 1176 and the transmit and receive circuitry 1174.

As described throughout this disclosure, a physical asset need not have any thematic relationship with a digital asset to generate an advertisement event. Physical assets (including services) may be completely different from a digital asset, and vice versa. For example, a soda purchase can be matched to receiving a horse mount in a role-playing game, even though the soda has little to no physical or thematic correlation with a horse. Accordingly, physical assets can be matched with virtually any type of digital asset (and vice-versa), which allows for economic parity between merchants and digital-asset providers that normally would not coordinate together to promote assets. Additionally, matching of physical and digital assets can be done with dynamic and equitable valuation so that one asset is not substantially over-valued or under-valued relative to a paired asset.

The methods and techniques described herein may be implemented in digital electronic circuitry, or with a programmable processor (for example, a special-purpose processor or a general-purpose processor such as a computer) firmware, software, or in various combinations of each. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instruction to, a data storage system, at least one input device, and at least one output device. Generally, a processor will receive instructions and data from a read-only memory and/or a random-access memory. Storage devices suitable for tangibly embodying computer program instructions and data include all forma of non-volatile memory, including by way of example semiconductor memory devices, such as erasable programmable read-only memory (EPROM), electrically-erasable programmable read-only memory (EEPROM), and flash memory devices; magnetic disks such as internal hard disks and removable disks; magneto-optical disks; and digital video disks (DVDs). Any of the foregoing may be supplemented by, or incorporated in, specially-designed application-specific integrated circuits (ASICs) or field programmable gate arrays (FPGAs).

The terms “about” or “substantially” mean that the value or parameter specified may be somewhat altered, as long as the alteration does not result in nonconformance of the process or structure to the illustrated embodiment from the perspective of one having ordinary skill in the art. For instance, unless otherwise indicated, a numerical quantity modified by the term “substantially” can be altered to within ±20% of the specified value. Finally, the term “exemplary” merely indicates the accompanying description is used as an example, rather than implying an ideal, essential, or preferable feature of the invention.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

1-81. (canceled)

82. An apparatus, comprising:
a first interface configured for coupling to a first computer system of a first party;
a second interface configured for coupling to a second computer system of a second party; and
a computer circuit coupled to the first and second interfaces and configured to:
receive, from the first party, information regarding an action taken by a third party and related to the first party,
associate the action taken by the third party with a reward available from the second party,
associate the second party with a fourth party, and
notify the second party that the fourth party is eligible for the reward.

83. The apparatus of claim 82 wherein the first party or the second party includes a merchant.

84. The apparatus of claim 82 wherein the first party or the second party includes a gaming-platform host.

85. The apparatus of claim 82 wherein the third party includes a consumer.

86. The apparatus of claim 82 wherein the fourth party includes a gamer.

87. The apparatus of claim 82 wherein the reward includes a physical asset or a digital asset.

88. The apparatus of claim 82 wherein the third party and the fourth party can be a same party.

89. The apparatus of claim 82 wherein the first interface or the second interface includes an application programming interface.

90. The apparatus of claim 82 wherein the computer circuit is configured to track reward eligibility across multiple parties.

91. The apparatus of claim 82 wherein the computer circuit is configured to:
receive, via the first interface or the second interface for at least one physical asset or for at least one digital asset, information regarding physical-asset inventory levels, digital-asset rarity, physical-asset price, digital-asset price, physical-asset purchase history, or digital-asset purchase history;
receive, via the first interface or the second interface for the third party or the fourth party, information regarding behavior of the third party related to the first party or the second party, behavior of the fourth party related to the first party or the second party, engagement of the third party related to the first party or the second party, engagement of the fourth party related to the first party or the second party;
calculate, in response to the received information, information received from services or providers external to the first interface, second interface, and computer circuit, and at least one characteristic of the third party or the fourth party relative to the first party or to the second party, a respective score for each of at least one combination of at least one physical asset and at least one digital asset; and
select, in response to the one or more calculated scores, one or more of the at least one combination for including in an advertisement.

92. The apparatus of claim 91 wherein the computer circuit is configured to recalculate, in response to changes in received information, to changes in information received from services or providers external to the first interface, second interface, and computer circuit, and changes to at least one characteristic of the third party or the fourth party relative to the first party or to the second party, the scores and combinations used in an advertisement in order to remove or modify an active advertisement.

93. A method, comprising:
associating a reward available from a first party with an action that is:
taken by a second party, and
related to a third party;
associating the second party with a fourth party; and
notifying the first party that the fourth party is eligible for the reward.

94. The method of claim 93, further comprising recording the action performed by the second party in a database that is independent of the first party and the third party.

95. The method of claim 93 wherein taking the action includes purchasing a physical asset or a digital asset.

96. The method of claim 93 wherein taking the action includes taking the action relative to a physical asset or a digital asset.

97. The method of claim 93 wherein associating the reward includes associating a physical asset or a digital asset.

98. The method of claim 93, further comprising:
receiving, from the third party, an identification of the action; and
receiving, from the first party, an identification of the reward.

99. The method of claim 93, further comprising advertising to the third party that the reward is available for the second party taking action.

100. The method of claim 93, wherein the advertising includes providing, to the third party, a digitally encoded advertisement message having identifier codes that associate the second party and with the fourth party.

101. The method of claim 93, further comprising associating the reward with the taking of the action in response to a promotion by the first party or the third party.

102. A tangible, non-transitory computer-readable medium storing instructions that, when executed by a computer circuit, cause the computer circuit to:
associate a reward available from a first party with an action that is:
taken by a second party, and
related to a third party;
associate the second party with a fourth party; and
notify the first party that the fourth party is eligible to receive the reward.

103. The computer-readable medium of claim 102 wherein the action includes purchasing a physical asset or a digital asset.

104. The computer-readable medium of claim 102 wherein the reward includes a physical asset or digital asset.

105. The computer-readable medium of claim 102 wherein the instructions, when executed by the computer circuit, cause the computer circuit to advertise to the second party or the fourth party an association of the reward with the action.

106. The computer-readable medium of claim 102 wherein the instructions, when executed by the computer circuit, cause the computer circuit to associate the reward with the action in response to a promotion by the first party or the third party.

107. The computer-readable medium of claim 102 wherein the instructions, when executed by the computer circuit, cause the computer circuit to track rewards for the second party.

108. The computer-readable medium of claim 102 wherein the instructions, when executed by the computer circuit, cause the computer circuit to link reward issuance to metrics relative to engagement of the second party or the fourth party with the first party or the second party.

109. The computer-readable medium of claim 102 wherein the instructions, when executed by the computer circuit, cause the computer circuit to verify reward eligibility of the second party or the fourth party in response to criteria established by the first party or the third party.

110. The computer-readable medium of claim 102 wherein the instructions, when executed by the computer circuit, cause the computer circuit to notify the first party or the third party of reward eligibility or reward issuance to the fourth party.

111. The computer-readable medium of claim 102 wherein the instructions, when executed by the computer circuit, cause the computer circuit to receive a notification from the first party or the third party of reward delivery to the fourth party.

112. The computer-readable medium of claim 102 wherein the instructions, when executed by the computer circuit, cause the computer circuit to:
determine, in response to the second party taking the action satisfying at least one condition of a promotion run by the first party or the third party, that the fourth party is eligible for the reward; and
notify the second party or the fourth party that the fourth party is eligible for the reward.

113. The computer-readable medium of claim 112 wherein the instructions, when executed by the computer circuit, cause the computer circuit to:
determine that the fourth party has no access to the reward; and
provide the fourth party with access to the first party or the second party to receive the reward.
